(19) United States
(12) Patent Application Publication
(10) Pub. No.: US 2025/0301428 A1
(43) Pub. Date: Sep. 25, 2025

(54) SPATIAL BEAM PREDICTION FOR DUAL-CYCLE SYNCHRONIZATION SIGNAL BLOCK BURSTS

(71) Applicant: QUALCOMM Incorporated, San Diego, CA (US)

(72) Inventors: Qiaoyu LI, Beijing (CN); Arumugam CHENDAMARAI KANNAN, San Diego, CA (US); Mahmoud TAHERZADEH BOROUJENI, San Diego, CA (US)

(21) Appl. No.: 18/609,858

(22) Filed: Mar. 19, 2024

(51) Int. Cl. H04W 56/00; H04L 5/00; H04W 72/02; H04W 74/0833

(52) U.S. Cl. CPC H04W 56/0015; H04L 5/0051; H04W 72/02; H04W 74/0833

(57) ABSTRACT

Methods, systems, and devices for wireless communications are described for beam measurement and selection using separate synchronization signal block (SSB) bursts for wide beams and narrow beams, where a periodicity of SSB bursts of narrow beams may be longer than a periodicity of SSB bursts with wide beams. A user equipment (UE) may predict narrow beam measurements (such as using an artificial intelligence or machine learning (AI/ML) model) at occasions of the wide beam SSBs that do not include the narrow beam SSBs. The UE may identify control resource set or remaining minimum system information resources, or random access channel resources for a random access transmission, based on the measured and predicted measurements.

### FIELD OF TECHNOLOGY

The following relates to wireless communications, including spatial beam prediction for dual-cycle synchronization signal block bursts.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support spatial beam prediction for dual-cycle synchronization signal block bursts. For example, the described techniques provide for separate synchronization signal block (SSB) bursts for wide beams and narrow beams, where a periodicity of SSB bursts of narrow beams is longer than a periodicity of SSB bursts with wide beams. A user equipment (UE) may predict narrow beam measurements (e.g., using an artificial intelligence or machine learning (AI/ML) model) at occasions of the wide beam SSBs that do not include the narrow beam SSBs. The UE may identify control resource set (CORESET) or remaining minimum system information (RMSI) resources, or random access channel (RACH) resources for a RACH transmission, based on the measured and predicted measurements.

In some aspects, SSB bursts of a first subset of SSBs having narrow beams and a second subset of SSBs having wide beams may have different symbol structures. For example, SSBs in the second subset of SSBs may include symbols for a primary synchronization signal (PSS), a secondary synchronization signal (SSS), and a physical broadcast channel (PBCH), and SSBs of the first subset of SSBs may include symbols for only PSS, only SSS, or both PSS and SSS. In some aspects, a CORESET or RMSI allocation may be associated with only SSBs in the first subset, only SSBs in the second subset, both subsets, or may be indicated based on synchronization sequence or bit(s) in the PBCH. Additionally, or alternatively, RACH resources may be only associated with SSBs of the first subset of SSBs, the second subset of SSBs, both the first and second subsets of SSBs, or indicated in signaling (e.g., RMSI can indicate presence of RACH resources for SSBs).

In some aspects, correspondence between beams of the first and second subsets of SSBs may include predefined quasi-co-location (QCL) relationships between SSBs of each set, or such relationships may be indicated via PSS, SSS, or PBCH (e.g., by a synchronization signal sequence, or bit(s) in PBCH). In some aspects, AI/ML models may be selected at the UE based on indicated model IDs (e.g., indicated via PSS, SSS, PBCH, or RMSI), or actually transmitted SSBs in the first and second subsets of SSBs. Additionally, or alternatively, the AI/ML model may be selected based on a geographical location or zone of the UE, based on measured RSRPs of SSBs, or any combination thereof. Measurement reports transmitted by a UE may include actual measurements, predicted measurements or both, based on when a report is transmitted relative to when actual measurements were obtained.

A method for wireless communications by a user equipment (UE) is described. The method may include obtaining a set of measured reference signal values from one or more reference signals of a first subset of synchronization signal blocks (SSBs) in a first SSB burst and one or more reference signals of a second subset of SSBs in a second SSB burst, where the first SSB burst and the second SSB burst are transmitted in a first set of wireless resources, and the first subset of SSBs is transmitted using a different set of transmit spatial filters than the second subset of SSBs, predicting one or more reference signal measurements for one or more SSBs of the first subset of SSBs for a second set of wireless resources to obtain a set of predicted reference signal values, where the first subset of SSBs is absent from the second set of wireless resources, and selecting one of a control resource set or a set of random access resources for a random access transmission based on the set of measured reference signal values and the set of predicted reference signal values.

A UE for wireless communications is described. The UE may include one or more memories storing processor executable code, and one or more processors coupled with the one or more memories. The one or more processors may individually or collectively be operable to execute the code to cause the UE to obtain a set of measured reference signal values from one or more reference signals of a first subset of SSBs in a first SSB burst and one or more reference signals of a second subset of SSBs in a second SSB burst, where the first SSB burst and the second SSB burst are transmitted in a first set of wireless resources, and the first subset of SSBs has a different set of transmit spatial filters than the second subset of SSBs, predict one or more reference signal measurements for one or more SSBs of the first subset of SSBs for a second set of wireless resources to obtain a set of predicted reference signal values, where the first subset of SSBs is absent from the second set of wireless resources, and select one of a control resource set or a set of random access resources for a random access transmission based on the set of measured reference signal values and the set of predicted reference signal values.

Another UE for wireless communications is described. The UE may include means for obtaining a set of measured reference signal values from one or more reference signals of a first subset of SSBs in a first SSB burst and one or more reference signals of a second subset of SSBs in a second SSB burst, where the first SSB burst and the second SSB burst are transmitted in a first set of wireless resources, and the first subset of SSBs is transmitted using a different set of transmit spatial filters than the second subset of SSBs, means for predicting one or more reference signal measurements for one or more SSBs of the first subset of SSBs for a second set of wireless resources to obtain a set of predicted reference signal values, where the first subset of SSBs is absent from the second set of wireless resources, and means for selecting one of a control resource set or a set of random access resources for a random access transmission based on the set of measured reference signal values and the set of predicted reference signal values.

A non-transitory computer-readable medium storing code for wireless communications is described. The code may include instructions executable by one or more processors to obtain a set of measured reference signal values from one or more reference signals of a first subset of SSBs in a first SSB burst and one or more reference signals of a second subset of SSBs in a second SSB burst, where the first SSB burst and the second SSB burst are transmitted in a first set of wireless resources, and the first subset of SSBs is transmitted using a different set of transmit spatial filters than the second subset of SSBs, predict one or more reference signal measurements for one or more SSBs of the first subset of SSBs for a second set of wireless resources to obtain a set of predicted reference signal values, where the first subset of SSBs is absent from the second set of wireless resources, and select one of a control resource set or a set of random access resources for a random access transmission based on the set of measured reference signal values and the set of predicted reference signal values.

In some examples of the method, UEs, and non-transitory computer-readable medium described herein, the first subset of SSBs may be transmitted at a first periodicity and the second subset of SSBs may be transmitted at a second periodicity, and where the first periodicity divided by the second periodicity is an integer value that is greater than or equal to 2.

In some examples of the method, UEs, and non-transitory computer-readable medium described herein, the selecting one of the control resource set or the set of random access resource may include operations, features, means, or instructions for selecting a first control resource set or a first random access resource associated with a first SSB of the first subset of SSBs or a first SSB of the second subset of SSBs, where the first SSB of the first subset of SSBs and the first SSB of second subset of SSBs may be a same SSB or a different SSB, and where the first SSB of the first subset of SSBs or the first SSB of second subset of SSBs has a reference signal measurement value or a predicted reference signal value that indicates more favorable channel conditions than other reference signal measurement values or predicted reference signal values of other SSBs of the first subset of SSBs or the second subset of SSBs.

In some examples of the method, UEs, and non-transitory computer-readable medium described herein, the first subset of SSBs and the second subset of SSBs each include one or more SSBs having one or more symbol structures that include one or more combinations of a first quantity of symbols that include a primary synchronization signal, a second quantity of symbols that include a secondary synchronization signal, and a third quantity of symbols that include a physical broadcast channel. In some examples of the method, UEs, and non-transitory computer-readable medium described herein, each SSB of both the first subset of SSBs and the second subset of SSBs may have a same symbol structure. In some examples of the method, UEs, and non-transitory computer-readable medium described herein, each SSB of the second subset of SSBs includes one or more symbols that contain the primary synchronization signal, and each SSB of the first subset of SSBs includes one or more symbols that contain the secondary synchronization signal and the physical broadcast channel. In some examples of the method, UEs, and non-transitory computer-readable medium described herein, each SSB of the second subset of SSBs may have a symbol structure that includes the primary synchronization signal, the secondary synchronization signal, and the physical broadcast channel and each SSB of the first subset of SSBs may have a symbol structure that includes only the primary synchronization signal, only the secondary synchronization signal, or both the primary synchronization signal and the secondary synchronization signal.

In some examples of the method, UEs, and non-transitory computer-readable medium described herein, the control resource set, a remaining minimum system information communication, or both, may be provided only via one or more beams associated with SSBs of the second subset of SSBs.

Some examples of the method, UEs, and non-transitory computer-readable medium described herein may further include operations, features, means, or instructions for selecting one or more beams to monitor for the control resource set, a remaining minimum system information communication, or both, based on the selected control resource set or random access resources, where the one or more beams to monitor may be determined based on one or more of a sequence of a primary synchronization signal, a sequence of a secondary synchronization signal, or an indication included in a physical broadcast channel, transmitted in a SSB associated with the selected control resource set or random access resources.

In some examples of the method, UEs, and non-transitory computer-readable medium described herein, the set of random access resources for the random access transmission may be selected from a set of multiple available sets of random access resources associated with only the first subset of SSBs. In some examples of the method, UEs, and non-transitory computer-readable medium described herein, the set of random access resources for the random access transmission may be indicated by a remaining minimum system information transmission associated with a SSB that may be selected based on the set of reference signal measurement values and the predicted reference signal measurement values of the first subset of SSBs.

In some examples of the method, UEs, and non-transitory computer-readable medium described herein, the first set of wireless resources include a first set of temporal locations within a single cycle associated with the first SSB burst and the second SSB burst, and where a first set of transmit spatial filters of the first subset of SSBs at a first temporal location of the first set of temporal locations has a predefined quasi-co-location (QCL) relationship to a second set of transmit spatial filters of the second subset of SSBs at a second temporal location of the first set of temporal locations. In some examples of the method, UEs, and non-transitory computer-readable medium described herein, the first set of wireless resources include a first set of temporal locations within a single cycle associated with the first SSB burst and the second SSB burst, and where a first set of transmit spatial filters of the first subset of SSBs is indicated by one or more of a synchronization signal sequence or an indicator of a physical broadcast channel of one or more SSBs of the second subset of SSBs.

Some examples of the method, UEs, and non-transitory computer-readable medium described herein may further include operations, features, means, or instructions for selecting an artificial intelligence model for predicting the one or more reference signal measurements based on a model ID or an identification of transmitted SSBs in the first subset of SSBs that may be provided in the second subset of SSBs. Some examples of the method, UEs, and non-transitory computer-readable medium described herein may further include operations, features, means, or instructions for selecting an artificial intelligence model for predicting the one or more reference signal measurements based on a geographical location of the UE and a set of candidate models associated with different geographical locations. Some examples of the method, UEs, and non-transitory computer-readable medium described herein may further include operations, features, means, or instructions for selecting an artificial intelligence model for predicting the one or more reference signal measurements based on the measured reference signal values of the first subset of SSBs and second subsets of SSBs.

Some examples of the method, UEs, and non-transitory computer-readable medium described herein may further include operations, features, means, or instructions for receiving a scheduling message that indicates that a measurement report is to be transmitted that includes at least a portion of the set of predicted reference signal values. In some examples of the method, UEs, and non-transitory computer-readable medium described herein, at least the portion of the set of predicted reference signal values may be provided in the measurement report when a reporting periodicity of the measurement report is shorter than a transmission periodicity of the first subset of SSBs. In some examples of the method, UEs, and non-transitory computer-readable medium described herein, at least a portion of the set of measured reference signal values may be provided in the measurement report in response to a trigger for an aperiodic measurement report when a timer associated with corresponding measurements is unexpired, and at least the portion of the set of predicted reference signal values may be provided in the response to the trigger when the timer associated with the corresponding measurements is expired, and where a duration of the timer corresponds to a periodicity of the second subset of SSBs. In some examples of the method, UEs, and non-transitory computer-readable medium described herein, a bandwidth, a quantity of physical resource blocks, a quantity of resource elements, or any combination thereof, of the first subset of SSBs may be the same or different than the second subset of SSBs, and where the first subset of SSBs may have a same quantity or a different quantity of transmit spatial filters as the second subset of SSBs.

A method for wireless communications by a network entity is described. The method may include configuring a UE to obtain a set of measured reference signal values and a set of predicted reference signal values, where the set of measured reference signal values is configured to be obtained from one or more reference signals of a first subset of SSBs in a first SSB burst and one or more reference signals of a second subset of SSBs in a second SSB burst, the first SSB burst and the second SSB burst transmitted in a first set of wireless resources, and where the set of predicted reference signal values is configured to be obtained for the first subset of SSBs for a second set of wireless resources in which the first subset of SSBs is absent, transmitting, in the first set of wireless resources, one or more reference signals of the first subset of SSBs in a first instance of the first SSB burst and one or more reference signals of the second subset of SSBs in a first instance of the second SSB burst, where the first subset of SSBs is transmitted using a different set of transmit spatial filters than the second subset of SSBs, transmitting, in the second set of wireless resources, one or more reference signals of the second subset of SSBs in a second instance of the second SSB burst, and receiving a random access message from the UE in a set of random access resources, where the set of random access resources is associated with at least one SSB of the first subset of SSBs or the second subset of SSBs.

A network entity for wireless communications is described. The network entity may include one or more memories storing processor executable code, and one or more processors coupled with the one or more memories. The one or more processors may individually or collectively be operable to execute the code to cause the network entity to configure a UE to obtain a set of measured reference signal values and a set of predicted reference signal values, where the set of measured reference signal values is configured to be obtained from one or more reference signals of a first subset of SSBs in a first SSB burst and one or more reference signals of a second subset of SSBs in a second SSB burst, the first SSB burst and the second SSB burst transmitted in a first set of wireless resources, and where the set of predicted reference signal values is configured to be obtained for the first subset of SSBs for a second set of wireless resources in which the first subset of SSBs is absent, transmit, in the first set of wireless resources, one or more reference signals of the first subset of SSBs in a first instance of the first SSB burst and one or more reference signals of the second subset of SSBs in a first instance of the second SSB burst, where the first subset of SSBs is transmitted using a different set of transmit spatial filters than the second subset of SSBs, transmit, in the second set of wireless resources, one or more reference signals of the second subset of SSBs in a second instance of the second SSB burst, and receive a random access message from the UE in a set of random access resources, where the set of random access resources is associated with at least one SSB of the first subset of SSBs or the second subset of SSBs.

Another network entity for wireless communications is described. The network entity may include means for configuring a UE to obtain a set of measured reference signal values and a set of predicted reference signal values, where the set of measured reference signal values is configured to be obtained from one or more reference signals of a first subset of SSBs in a first SSB burst and one or more reference signals of a second subset of SSBs in a second SSB burst, the first SSB burst and the second SSB burst transmitted in a first set of wireless resources, and where the set of predicted reference signal values is configured to be obtained for the first subset of SSBs for a second set of wireless resources in which the first subset of SSBs is absent, means for transmitting, in the first set of wireless resources, one or more reference signals of the first subset of SSBs in a first instance of the first SSB burst and one or more reference signals of the second subset of SSBs in a first instance of the second SSB burst, where the first subset of SSBs is transmitted using a different set of transmit spatial filters than the second subset of SSBs, means for transmitting, in the second set of wireless resources, one or more reference signals of the second subset of SSBs in a second instance of the second SSB burst, and means for receiving a random access message from the UE in a set of random access resources, where the set of random access resources is associated with at least one SSB of the first subset of SSBs or the second subset of SSBs.

A non-transitory computer-readable medium storing code for wireless communications is described. The code may include instructions executable by one or more processors to configure a UE to obtain a set of measured reference signal values and a set of predicted reference signal values, where the set of measured reference signal values is configured to be obtained from one or more reference signals of a first subset of SSBs in a first SSB burst and one or more reference signals of a second subset of SSBs in a second SSB burst, the first SSB burst and the second SSB burst transmitted in a first set of wireless resources, and where the set of predicted reference signal values is configured to be obtained for the first subset of SSBs for a second set of wireless resources in which the first subset of SSBs is absent, transmit, in the first set of wireless resources, one or more reference signals of the first subset of SSBs in a first instance of the first SSB burst and one or more reference signals of the second subset of SSBs in a first instance of the second SSB burst, where the first subset of SSBs is transmitted using a different set of transmit spatial filters than the second subset of SSBs, transmit, in the second set of wireless resources, one or more reference signals of the second subset of SSBs in a second instance of the second SSB burst, and receive a random access message from the UE in a set of random access resources, where the set of random access resources is associated with at least one SSB of the first subset of SSBs or the second subset of SSBs.

In some examples of the method, network entities, and non-transitory computer-readable medium described herein, the first subset of SSBs may be transmitted at a first periodicity and the second subset of SSBs may be transmitted at a second periodicity, and where the first periodicity divided by the second periodicity is an integer value that is greater than or equal to 2.

In some examples of the method, network entities, and non-transitory computer-readable medium described herein, configuring the UE may include operations, features, means, or instructions for configuring the UE to select a first control resource set or a first random access resource associated with a first SSB of the first subset of SSBs or a first SSB of the second subset of SSBs, where the first SSB of the first subset of SSBs and the first SSB of second subset of SSBs may be a same SSB or a different SSB, and where the first SSB of the first subset of SSBs or the first SSB of second subset of SSBs may have a reference signal measurement value or a predicted reference signal value that indicates more favorable channel conditions than other reference signal measurement values or predicted reference signal values of other SSBs of the first subset of SSBs or the second subset of SSBs.

In some examples of the method, network entities, and non-transitory computer-readable medium described herein, the first subset of SSBs and the second subset of SSBs each include one or more SSBs having one or more symbol structures that include one or more combinations of a first quantity of symbols that include a primary synchronization signal, a second quantity of symbols that include a secondary synchronization signal, and a third quantity of symbols that include a physical broadcast channel.

In some examples of the method, network entities, and non-transitory computer-readable medium described herein, each SSB of both the first subset of SSBs and the second subset of SSBs may have a same symbol structure. In some examples of the method, network entities, and non-transitory computer-readable medium described herein, each SSB of the second subset of SSBs includes one or more symbols that contain the primary synchronization signal, and each SSB of the first subset of SSBs includes one or more symbols that contain the secondary synchronization signal and the physical broadcast channel. In some examples of the method, network entities, and non-transitory computer-readable medium described herein, each SSB of the second subset of SSBs may have a symbol structure that includes the primary synchronization signal, the secondary synchronization signal, and the physical broadcast channel and each SSB of the first subset of SSBs may have a symbol structure that includes only the primary synchronization signal, only the secondary synchronization signal, or both the primary synchronization signal and the secondary synchronization signal.

In some examples of the method, network entities, and non-transitory computer-readable medium described herein, a control resource set, a remaining minimum system information communication, or both, may be provided only via one or more beams associated with SSBs of the second subset of SSBs.

Some examples of the method, network entities, and non-transitory computer-readable medium described herein may further include operations, features, means, or instructions for transmitting a control resource set, a remaining minimum system information communication, or both, using at least a first beam that may be indicated by one or more of a sequence of a primary synchronization signal of one or more reference signal transmissions, a sequence of a secondary synchronization signal one or more reference signal transmissions, or an indication included in a physical broadcast channel of a SSB associated with the control resource set or random access resources.

In some examples of the method, network entities, and non-transitory computer-readable medium described herein, the set of random access resources for the random access message may be one of a set of multiple available sets of random access resources associated with only the first subset of SSBs. In some examples of the method, network entities, and non-transitory computer-readable medium described herein, the set of random access resources for the random access message may be indicated by a remaining minimum system information transmission associated with a SSB that is selected by the UE based on the set of reference signal measurements and the predicted reference signal measurements of the first subset of SSBs.

In some examples of the method, network entities, and non-transitory computer-readable medium described herein, the first set of wireless resources include a first set of temporal locations within a single cycle associated with the first SSB burst and the second SSB burst, and where a first set of transmit spatial filters of the first subset of SSBs may have a predefined QCL relationship to a second set of transmit spatial filters of the second subset of SSBs. In some examples of the method, network entities, and non-transitory computer-readable medium described herein, the first set of wireless resources include a first set of temporal locations within a single cycle associated with the first SSB burst and the second SSB burst, and where a first set of transmit spatial filters of the first subset of SSBs may be indicated by one or more of a synchronization signal sequence or an indicator of a physical broadcast channel of one or more SSBs of the second subset of SSBs.

Some examples of the method, network entities, and non-transitory computer-readable medium described herein may further include operations, features, means, or instructions for providing an indication to the UE of an artificial intelligence model for predicting the set of predicted reference signal values based on a model ID or an identification of transmitted SSBs in the first subset of SSBs that may be provided in the second subset of SSBs. In some examples of the method, network entities, and non-transitory computer-readable medium described herein, an artificial intelligence model for predicting the set of predicted reference signal values may be identified based on a geographical location of the UE and a set of candidate models associated with different geographical locations. In some examples of the method, network entities, and non-transitory computer-readable medium described herein, an artificial intelligence model for predicting the set of predicted reference signal values may be identified based on the measured reference signal values of the first subset of SSBs and second subsets of SSBs.

Some examples of the method, network entities, and non-transitory computer-readable medium described herein may further include operations, features, means, or instructions for transmitting a scheduling message to the UE that indicates that a measurement report is to be provided that includes at least a portion of the set of predicted reference signal values. In some examples of the method, network entities, and non-transitory computer-readable medium described herein, at least the portion of the set of predicted reference signal values may be provided in the measurement report when a reporting periodicity of the measurement report is shorter than a transmission periodicity of the first subset of SSBs. In some examples of the method, network entities, and non-transitory computer-readable medium described herein, at least a portion of the set of measured reference signal values may be provided in the measurement report in response to a trigger for an aperiodic measurement report when a timer associated with corresponding measurements is unexpired, and at least the portion of the set of predicted reference signal values may be provided in the response to the trigger when the timer associated with the corresponding measurements is expired, and where a duration of the timer corresponds to a periodicity of the second subset of SSBs.

In some examples of the method, network entities, and non-transitory computer-readable medium described herein, a bandwidth, a quantity of physical resource blocks, a quantity of resource elements, or any combination thereof, of the first subset of SSBs may be the same or different than the second subset of SSBs, and where the first subset of SSBs may have a same quantity or a different quantity of transmit spatial filters as the second subset of SSBs.

### BRIEF DESCRIPTION OF THE DRAWINGS

FIG. 1 shows an example of a wireless communications system that supports spatial beam prediction for dual-cycle synchronization signal block (SSB) bursts in accordance with one or more aspects of the present disclosure.

FIG. 2 shows an example of a wireless communications system that supports spatial beam prediction for dual-cycle SSB bursts in accordance with one or more aspects of the present disclosure.

FIG. 3 shows an example of a SSB burst scheme that supports spatial beam prediction for dual-cycle SSB bursts in accordance with one or more aspects of the present disclosure.

FIG. 4 shows an example of a SSB burst scheme that supports spatial beam prediction for dual-cycle SSB bursts in accordance with one or more aspects of the present disclosure.

FIG. 5 shows an example of a SSB burst scheme that supports spatial beam prediction for dual-cycle SSB bursts in accordance with one or more aspects of the present disclosure.

FIG. 6 shows an example of a flowchart illustrating a method that supports spatial beam prediction for dual-cycle SSB bursts in accordance with one or more aspects of the present disclosure.

FIG. 7 shows an example of a process flow that supports spatial beam prediction for dual-cycle SSB bursts in accordance with one or more aspects of the present disclosure.

FIG. 8 shows an example of a block diagram of an example ML architecture that supports spatial beam prediction for dual-cycle SSB bursts in accordance with one or more aspects of the present disclosure.

FIGS. 9 and 10 show block diagrams of devices that support spatial beam prediction for dual-cycle SSB bursts in accordance with one or more aspects of the present disclosure.

FIG. 11 shows a block diagram of a communications manager that supports spatial beam prediction for dual-cycle SSB bursts in accordance with one or more aspects of the present disclosure.

FIG. 12 shows a diagram of a system including a device that supports spatial beam prediction for dual-cycle SSB bursts in accordance with one or more aspects of the present disclosure.

FIGS. 13 and 14 show block diagrams of devices that support spatial beam prediction for dual-cycle SSB bursts in accordance with one or more aspects of the present disclosure.

FIG. 15 shows a block diagram of a communications manager that supports spatial beam prediction for dual-cycle SSB bursts in accordance with one or more aspects of the present disclosure.

FIG. 16 shows a diagram of a system including a device that supports spatial beam prediction for dual-cycle SSB bursts in accordance with one or more aspects of the present disclosure.

FIGS. 17 through 24 show flowcharts illustrating methods that support spatial beam prediction for dual-cycle SSB bursts in accordance with one or more aspects of the present disclosure.

### DETAILED DESCRIPTION

In some wireless communications networks, wireless devices may communicate via directional transmission beams. When selecting beams for communications, a transmitting device (e.g, a network node such as a gNB) may perform a beam sweep with relatively broad or wide beams, and a receiving device (e.g., a user equipment (UE)), may detect one or more beams and initiate communications based on the detected beam(s). The transmitting and receiving devices may subsequently identify one or more narrower beams that may provide reliable communications. Such techniques may provide for communications using relatively narrow beams, but training procedures to identify narrow beams may consume wireless resources and result in relatively long latencies between initial access and communications via the selected beams. In some cases, prior to initial access, a transmitting device may transmit relatively narrow beams along with relatively wide beams. Such techniques may enhance beam selection at a receiving device and therefore reduce access latency and enhance a likelihood of reception of an initial access transmission. However, transmitting both narrow beams and wide beams in a beam sweep procedure may add overhead at a transmitting device, and also increases power consumption. In accordance with techniques discussed herein, a transmitting device may transmit some narrow beams to allow for enhanced beam selection while also not consuming substantial amounts of additional wireless resources or power.

In accordance with some aspects, described techniques provide for separate SSBs in a SSB burst for wide beams and narrow beams, where a periodicity of SSB bursts of narrow beams is longer than a periodicity of SSB bursts with wide beams. For example, a first subset of SSBs may be transmitted using narrow beams at a first periodicity (e.g., 60 ms), and a second subset of SSBs may be transmitted using wide beams at a second periodicity (e.g., 20 ms). A UE may predict narrow beam measurements (e.g., using an artificial intelligence or machine learning (AI/ML) model) at occasions of the wide beam SSBs that do not include the narrow beam SSBs. In some examples, the first periodicity divided by the second periodicity may be an integer value that is at least 2. The UE may identify control resource set (CORESET) or remaining minimum system information (RMSI) resources, or random access channel (RACH) resources for a RACH transmission, based on the measured and predicted measurements.

In some aspects, SSB bursts of a first subset of SSBs having narrow beams and a second subset of SSBs having wide beams may have different symbol structures. For example, SSBs in the second subset of SSBs may include symbols for a primary synchronization signal (PSS), a secondary synchronization signal (SSS), and a physical broadcast channel (PBCH), and SSBs of the first subset of SSBs may include symbols for only PSS, only SSS, or both PSS and SSS. In some aspects, a CORESET or RMSI allocation may be associated with only SSBs in the first subset, only SSBs in the second subset, both subsets, or may be indicated based on synchronization sequence or bit(s) in the PBCH. Additionally, or alternatively, RACH resources may be only associated with SSBs of the first subset of SSBs, the second subset of SSBs, both the first and second subsets of SSBs, or indicated in signaling (e.g., RMSI can indicate presence of RACH resources for SSBs).

In some aspects, correspondence between beams of the first and second subsets of SSBs may include predefined quasi-co-location (QCL) relationships between SSBs of each set, or such relationships may be indicated via PSS, SSS, or PBCH (e.g., by a synchronization signal sequence, or bit(s) in PBCH). In some aspects, AI/ML models may be selected at the UE based on indicated model IDs (e.g., indicated via PSS, SSS, PBCH, or RMSI), or actually transmitted SSBs in the first and second subsets of SSBs. Additionally, or alternatively, the AI/ML model may be selected based on a geographical location or zone of the UE, based on measured RSRPs of SSBs, or any combination thereof. Measurement reports transmitted by a UE may include actual measurements, predicted measurements or both, based on when a report is transmitted relative to when actual measurements were obtained.

Such techniques may provide for efficient selection of one or more beams for communications based on transmissions of both wide and narrow beams, while also transmitting narrow beams on fewer occasions than wide beams. Thus, described techniques enhance network efficiency, reliability, and throughput by allowing measurements and beam selection based on both wide and narrow beams. Such techniques also provide for relatively little increases in overhead associated with the narrow beam transmissions due to such transmissions having a lower periodicity than wide beam transmissions.

Aspects of the disclosure are initially described in the context of wireless communications systems. Aspects of the disclosure are further illustrated by and described with reference to resource diagrams, process flows, apparatus diagrams, system diagrams, and flowcharts that relate to spatial beam prediction for dual-cycle SSB bursts.

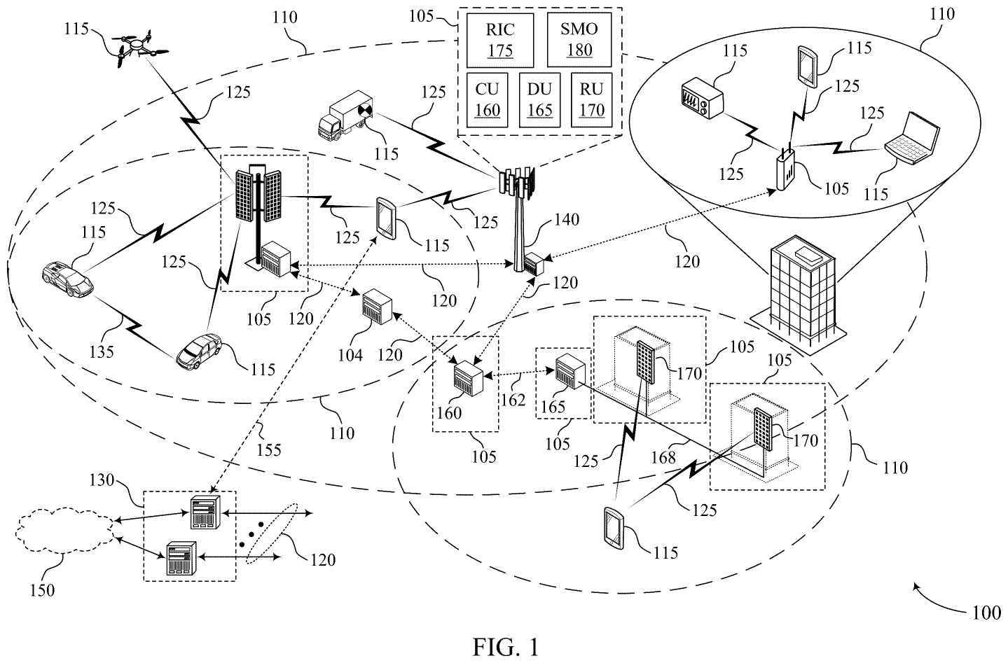

FIG. 1 shows an example of a wireless communications system 100 that supports spatial beam prediction for dual-cycle SSB bursts in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, one or more network entities 105 may transmit separate SSB bursts for wide beams and narrow beams, where a periodicity of SSB bursts of narrow beams is longer than a periodicity of SSB bursts with wide beams. A UE 115 may predict narrow beam measurements (e.g., using an AI/ML model) at occasions of the wide beam SSBs that do not include the narrow beam SSBs. In some cases, the UE 115 may identify CORESET (e.g., CORESET #0) or RMSI resources, or RACH resources for a RACH transmission, based on the measured and predicted measurements.

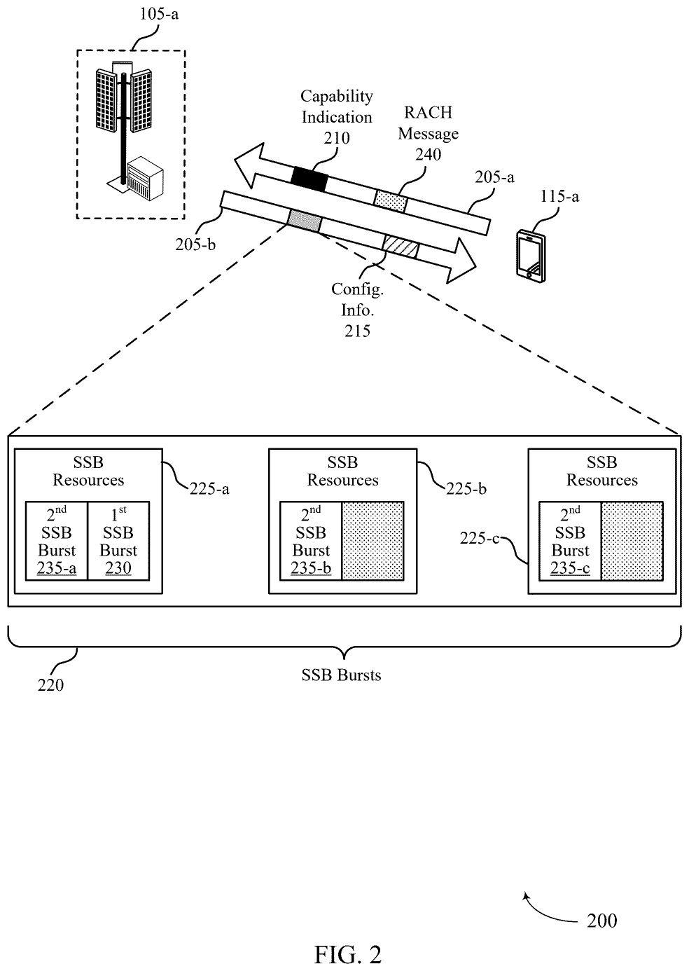

FIG. 2 shows an example of a wireless communications system 200 that supports spatial beam prediction for dual-cycle SSB bursts in accordance with one or more aspects of the present disclosure. In some examples, aspects of the wireless communications system 200 may implement, or be implemented by, aspects of the wireless communications system 100. In particular, the wireless communications system 200 illustrates signaling and configurations for spatial beam prediction for dual-cycle SSB bursts, as described herein.

The wireless communications system 200 may include a UE 115-a and a network entity 105-a, which may be examples of wireless devices as described herein. In some aspects, the UE 115-a and the network entity 105-a may communicate with one another using a communication link 205, which may be an example of an NR or LTE link, a sidelink (e.g., PC5 link), and the like, between the respective devices. In some cases, the communication link 205 may include an example of an access link (e.g., Uu link) which may include a bi-directional link that enables both uplink and downlink communication. For example, the UE 115-a may transmit uplink signals, such as uplink control signals or uplink data signals, to one or more components of the network entity 105-a using the communication link 205-a, and one or more components of the network entity 105-a may transmit downlink signals, such as downlink control signals or downlink data signals, to the UE 115-a using the communication link 205-b.

In some aspects, the UE 115-a may transmit a capability indication 210 to the network entity 105-a, which may indicate a capability of the UE 115-a to perform predictions for spatial beams. For example, the UE 115-a may indicate a capability to predict one or more beam measurements (e.g., layer1 reference signal received power (L1-RSRP) measurements) based on actual measurements of one or more wide beams, one or more narrow beams, or both. Additionally, in some aspects, the capability indication 210 may indicate one or more AI/ML models that are configured at the UE 115-a for performing predictions of one or more beam measurements.

In some aspects, the network entity 105-a may transmit configuration information 215 that indicates a dual-cycle SSB configuration of the network entity 105-a. For example, the configuration information 215 may indicate a first periodicity at which one or more narrow beam SSBs are to be transmitted, and a second periodicity at which one or more wide beam SSBs are to be transmitted. The configuration information 215 may be provided, for example, in one or more system information (SI) transmissions of the network entity 105-a. The network entity 105-a may transmit SSB bursts 220 in accordance with the dual-cycle SSB configuration. For example, as illustrated in FIG. 2, periodic SSB resources 225 may include a first subset of SSBs 230 that are transmitted using a first set of narrow beams, and a second subset of SSBs 235 that are transmitted using a second set of wide beams. As discussed herein, the first subset of SSBs 230 may have a longer first periodicity (e.g., 60 ms) than a second periodicity (e.g., 20 ms) the second subset of SSBs 235 such that a first set of SSB resources 225-a includes the first subset of SSBs 230 and a first instance of the second subset of SSBs 235-a, a second set of SSB resources 225-b includes a second instance of the second subset of SSBs 235-b, and a third set of SSB resources 225-c includes a third instance of the second subset of SSBs 235-c. In accordance with the longer first periodicity, the first subset of SSBs 230 are not transmitted in the second set of SSB resources 225-b or the third set of SSB resources 225-c. In some aspects, the UE 115-a may predict one or more measurements for SSBs of the first subset of SSBs 230 for the second set of SSB resources 225-b and the third set of SSB resources 225-c. The UE 115-a in this example may transmit a RACH message 240 (e.g., an initial access message such as a RACH Message 1 (Msg1) or RACH Message A (MsgA)) using RACH resources that are selected based at least in part on measurement values of measured SSBs, predicted values of SSB measurements, or both.

For example, the UE 115-a may identify (e.g., from system information of a cell associated with the network entity 105-a), a RACH resource for a Msg1 of MsgA random access message. In some cases, the UE 115-a may select different RACH resources based on whether a measured value or a predicted value is used to identify signal strengths of an associated SSB. In some cases, the RACH resources may include RACH occasions (ROs), PUSCH occasions (POs), or both, where POs are used when MsgA in two-step RACH procedures are implemented. In some cases, predicted values for one or more SSB bursts of the first subset of SSBs may be based on measurements of actual transmissions of the first subset of SSBs 230 and the second subset of SSBs 235, which may be referred to as wide+narrow-to-narrow prediction. In some cases, the first subset of SSBs 230 may include SSBs transmitted on a set of narrow beams (e.g., 8 beams), and actual SSB transmissions of the first subset of SSBs 230 may be provided for only a subset of the set of narrow beams (e.g., two beams that may be randomly selected). In other cases, actual SSB transmissions of the first subset of SSBs 230 may be provided for each beam of the set of narrow beams.

In some cases, an AI/ML model may be selected based on an actual quantity of SSB transmissions of the first subset of SSBs 230. For example, if SSBs are transmitted on fewer than all of the narrow beams, their RSRPs may be used as AI/ML inputs, to predict all narrow-beam RSRPs. In some aspects, SSBs may be transmitted using all narrow beams of the first subset of SSBs 230 once every three SSB cycles (e.g., where the second subset of SSBs are transmitted on each SSB cycle), and the UE 115-a may measure the transmitted SSBs of the first subset of SSBs 230, and their RSRPs may be used as AI/ML inputs, to predict all narrow-beam RSRPs of SSB cycles in which the first subset of SSBs 230 are not transmitted. In some aspects, the UE 115-a may transmit one or more measurement reports that indicate measured and predicted measurement values. For example, the UE 115-a may be configured with a periodic, semi-persistent, or aperiodic channel state information (CSI) setting, and a transmitted CSI report may include actual measurements, predicted measurements, or both.

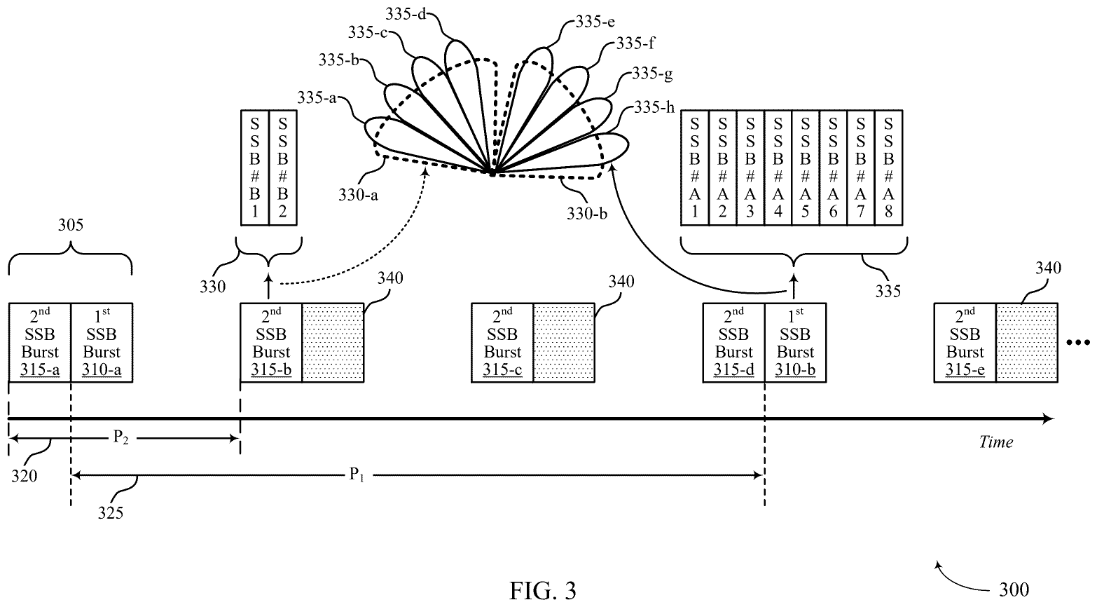

Details regarding the dual-cycle SSB bursts, symbol configurations for SSB transmissions, RACH resources associated with different SSBs, beam correspondence between narrow and wide beams, and AI/ML model identification and selection, are further shown and described with reference to the examples of FIGS. 3 through 8.

FIG. 3 shows an example of a SSB burst scheme 300 that supports spatial beam prediction for dual-cycle SSB bursts in accordance with one or more aspects of the present disclosure. In some examples, aspects of the SSB burst scheme 300 may implement, or be implemented by, aspects of the wireless communications systems 100 or 200. In particular, the SSB burst scheme 300 illustrates various implementations for dual-cycle SSB bursts in which a device that receives SSB transmission (e.g., a UE) may perform beam prediction for beams that are not transmitted in some SSB burst locations, as described herein.

In this example, periodic SSB bursts 305 may be configured in which a first subset of SSBs 310 and a second subset of SSBs 315 may be transmitted. In this example, the first subset of SSBs 310 may have a periodicity of P1 320 (e.g., 60 ms), and the second subset of SSBs 315 may have a periodicity of P2 325 (e.g., 20 ms), where P1/P2 is an integer value of greater than or equal to 2. In this example, a first instance of the first subset of SSBs 310-a may be transmitted in a same SSB burst 305 as a first instance of the second subset of SSBs 315-a. A second instance of the second subset of SSBs 315-b and a third instance of the second subset of SSBs 315-c may also be transmitted in subsequent SSB bursts that do not include SSBs of the first subset of SSBs 310. In accordance with the indicated periodicities, a second instance of the first subset of SSBs 310-b may be transmitted with a fourth instance of the second subset of SSBs 315-d, and then a fifth instance of the second subset of SSBs 315-e may be transmitted in a subsequent SSB burst that does not include SSBs of the first subset of SSBs 310.

In the example of FIG. 3, the second subset of SSBs 315 may include wide beam SSBs 330, including wide beam SSB #B1 330-a and wide beam SSB #B2 330-b. Further, the first subset of SSBs 310 may include narrow beam SSBs 335, including narrow beam SSB #A1 335-a through narrow beam SSB #A8 335-h. In some aspects, a UE may measure transmitted SSBs in each SSB burst 305, and in cases where the first subset of SSBs 310 are not transmitted, may generate predictions 340 of corresponding measurement values (e.g., predicted L1-RSRP values based on measured L1-RSRP values). In some aspects, the various SSBs associated with the first subset of SSBs 310 and the second subset of SSBs 315 may be transmitted with corresponding first and second sets of transmit spatial filters. That is, a first and second set of transmit spatial filters are considered as the first subset of SSBs 310 and the second subset of SSBs 315 beams, respectively. A UE may identify one or more preferred SSB(s) among SSBs transmitted by the SSB bursts, via detection of PSSs, SSSs, or both, associated with the SSBs in the first and second subsets of SSB bursts, at their expected transmission locations.

The UE may measure L1-RSRPs associated with the SSBs in the first subset of SSBs 310 and the second subset of SSBs 315 in a SSB burst 305 at their expected locations, and the UE may predict L1-RSRPs, or one or more predicted top SSBs (e.g., Top-K-SSBs) in terms of L1-RSRPs, for SSBs in the first subset of SSBs 310 at temporal locations of the second subset of SSBs 315 in which the first subset of SSBs 310 are not transmitted. The UE may identify CORESET (e.g., CORESET #0) resource, RMSI resources, or both, or may identify RACH resources (e.g., ROs/preambles/POs) for Msg1 or MsgA transmission, where the CORESET, RMSI, or RACH resources may be associated with the first subset of SSBs 310, the second subset of SSBs 315, or both, and the preferred SSB among the SSB burst 305 (e.g., based on a highest L1-RSRP). L1-RSRP values may be one example of measured or predicted reference signal values that may indicate more favorable channel conditions for use in selection of the CORESET, RMSI, or RACH resources, although other reference signal values may be used (e.g., a received a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received quality (RSRQ), and/or a block error rate (BLER)).

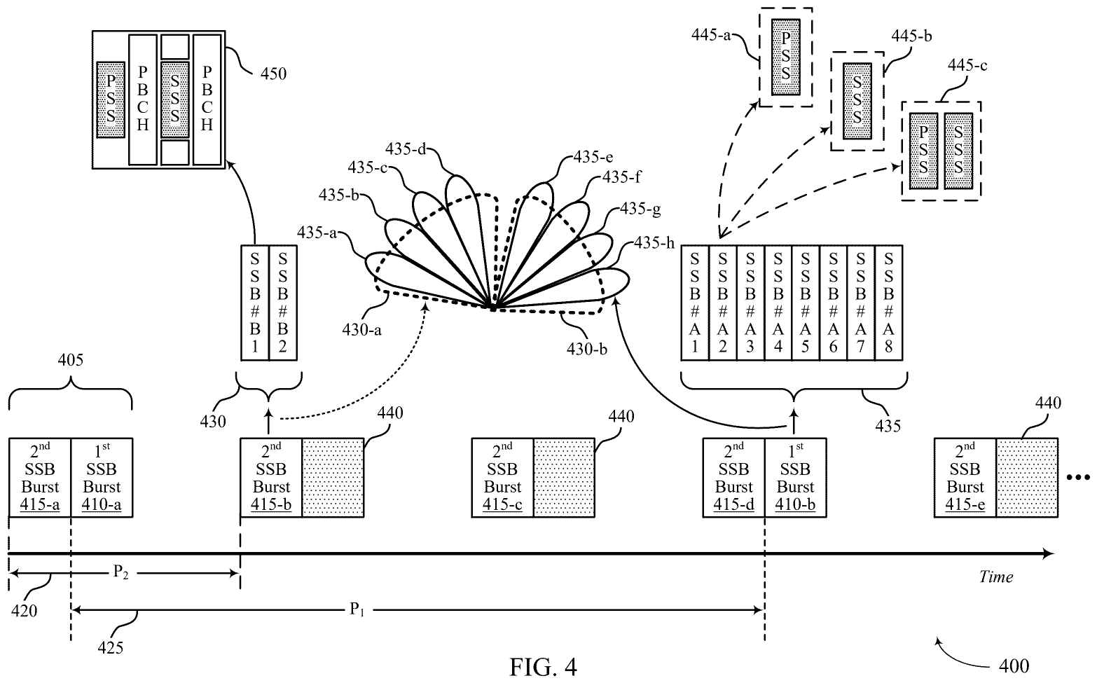

In some aspects, the SSB measurements and predictions may be performed when the UE is not in a connected mode (e.g., for initial access). In other aspects, beam predictions may be performed when the UE is in RRC-Connected mode. In some deployments, the network may only use the SSBs in the second subset of SSBs 315 (e.g., Set-B wide beams) to deliver RMSI. Further, RACH messages (e.g., Msg1/2/3/4 or MsgA/B), together with any traffic scheduling in RRC-Connected mode may be based on the first subset of SSBs 310 (e.g., Set-A narrow beams). In such cases, a symbol structure of the SSBs may be selected to provide relevant information via different SSBs. Examples of SSB symbol structures are discussed in more detail with reference to the examples of FIG. 4. For example, PSS, SSS, and PBCH symbols may be included in the second subset of SSBs 315, and PSS and SSS symbols may be included in the first subset of SSBs 310. Such a symbol structure may provide for reduced network energy consumption at the network, and provide efficient overhead usage while providing information for UE-specific initial access or RRC-connected mode throughput performance. In such cases, in RRC-connected mode, although the SSBs in the first subset of SSBs 310 are transmitted less frequently compared to the SSBs in the second subset of SSBs 315, the network may still schedule L1-reports addressing such SSBs in a 20 ms reporting periodicity. Consequently, the UE may update the L1-reports via UE-side beam prediction to predict L1-RSRPs of the SSBs in the first subset of SSBs 310 corresponding to their non-transmitted cycles.

In some aspects, a prediction AI/ML model can be based on the presence of SSBs in each configured SSB location of the first subset of SSBs 310 (e.g., SSB #A1 335-a though SSB #A8 335-h). In such cases, the network may schedule CSI report(s) (e.g., periodic, semi-persistent, aperiodic CSI reports) requesting predicted L1-RSRPs or Top-K-resources in terms of L1-RSRP strengths, on SSBs in the first subset of SSBs 310. The CSI reports may be scheduled, for periodic or semi-persistent CSI reports, based on a reporting periodicity (e.g., via P2=20 ms) shorter than the transmission periodicity (e.g., P1=80 ms) associated with the first subset of SSBs 310; and the UE may predict L1-RSRPs or Top-K-resources in terms of L1-RSRP strengths on such SSBs, for the reporting cycles in which the SSBs are not transmitted. The CSI reports may be scheduled, for aperiodic CSI reports, based on a timer that is reset to zero after the most recent transmission of the SSBs associated with the first subset of SSBs 310, and if the timer is expired (e.g., a predefined expiration duration that may correspond to the duration of P2) when the aperiodic CSI report is triggered, the UE may perform prediction on L1-RSRPs or Top-K-resources in terms of L1-RSRP strengths on such SSBs to derive the values (e.g., reportQuantity) associated with the CSI report.

In some aspects, a bandwidth, number of physical resource blocks (#PRBs), a number of resource elements (REs), or any combination thereof, occupied by the SSBs in the first subset of SSBs 310 and the second subset of SSBs 315 may be the same or different. In some cases, specific frequency occupations of SSBs may be predefined. Additionally, or alternatively, a quantity of SSBs in the first subset of SSBs 310 that are quasi-co-located (QCL′d) with a first SSB and a second SSB in the second subset of SSBs 315, can be the same or different.

FIG. 4 shows an example of a SSB burst scheme 400 that supports spatial beam prediction for dual-cycle SSB bursts in accordance with one or more aspects of the present disclosure. In some examples, aspects of the SSB burst scheme 400 may implement, or be implemented by, aspects of the wireless communications systems 100 or 200, the SSB burst scheme 400, or any combination thereof. In particular, the SSB burst scheme 300 illustrates various implementations for dual-cycle SSB bursts in which a device that receives SSB transmission (e.g., a UE) may perform beam prediction for beams that are not transmitted in some SSB burst locations, as described herein.

Similarly as discussed in the example of FIG. 3, in this example periodic SSB bursts 405 may be configured in which a first subset of SSBs 410 and a second subset of SSBs 415 may be transmitted. In this example, the first subset of SSBs 410 may have a periodicity of P1 420 (e.g., 60 ms), and the second subset of SSBs 415 may have a periodicity of P2 425 (e.g., 20 ms), where P1/P2 is an integer value of greater than or equal to two. In this example, a first instance of the first subset of SSBs 410-a may be transmitted in a same SSB burst 405 as a first instance of the second subset of SSBs 415-a. A second instance of the second subset of SSBs 415-b and a third instance of the second subset of SSBs 415-c may also be transmitted in subsequent SSB bursts that do not include SSBs of the first subset of SSBs 410. In accordance with the indicated periodicities, a second instance of the first subset of SSBs 410-b may be transmitted with a fourth instance of the second subset of SSBs 415-d, and then a fifth instance of the second subset of SSBs 415-e may be transmitted in a subsequent SSB burst that does not include SSBs of the first subset of SSBs 410. As in FIG. 3, the second subset of SSBs 415 may include wide beam SSBs 430 (e.g., wide beam SSB #B1 430-a and wide beam SSB #B2 430-b), and the first subset of SSBs 410 may include narrow beam SSBs 435 (e.g., including narrow beam SSB #A1 435-a through narrow beam SSB #A8 435-h). In some aspects, a UE may measure transmitted SSBs in each SSB burst 405, and in cases where the first subset of SSBs 410 are not transmitted, may generate predictions 440 of corresponding measurement values (e.g., predicted L1-RSRP values based on measured L1-RSRP values).

SSBs in the different subset of SSBs may have symbol composition structures that may be the same or different. In the example of FIG. 4, several examples of SSB composition structures are illustrated, which may include any combinations of X-symbol(s) of PSS (or a discovery reference signal (DRS)), Y-symbol(s) of SSS, and Z-symbol(s) of PBCH (and its associated DMRSs). Within a subset of SSBs, different SSBs may be based on the same composition structure, and a first SSB from the first subset of SSBs 410, and a second SSB from the second subset of SSBs 415, may be based on the same or different composition structure. In a first example, each SSB of both the first subset of SSBs 410 and the second subset of SSBs 415 may each have the same structure with PSS, SSS, and PBCH symbols for SSB. In a second example, SSBs of the second subset of SSBs 415 may have composition structure 450 that includes PSS, SSS, and PBCH symbols, and SSBs of the first subset of SSBs 410 may include only a PSS symbol as indicated in composition structure 445-a, may include only a SSS symbol as indicated in composition structure 445-b, or may include PSS and SSS symbols as indicated in composition structure 445-c. In some aspects, the composition structure of the second subset of SSBs 415 may be based on the composition structure of the first subset of SSBs 410. For example, if PSS is transmitted on beams of the second subset of SSBs 415, then beams of the first subset of SSBs 410 may include SSS and PBCH symbols. In other aspects, the second subset of SSBs 415 may include composition structure 450 with symbols for PSS, SSS, and PBCH, and the first subset of SSBs 410 may include composition structure 445-c with symbols for PSS and SSS. In such cases, the network may use the beams associated with the first subset of SSBs 410 (e.g., wider beams) to deliver RMSI since downlink coverage may be relatively good for RMSI transmissions, and the beams associated with the first subset of SSBs 410 (e.g., narrower beams) may be predicted at the UE based on occasional PSS and SSS receptions, and further used for RACH messages (e.g., Msg1/2/3/4 or MsgA/B), and also for RRC-Connected mode reports. In still further examples, PSS symbols may be transmitted via the second subset of SSBs 415 beams more frequently, while SSS and PBCH symbols may be transmitted via beams of the first subset of SSBs 410 beams less frequently.

In some aspects, various CORESET and RMSI allocation options may be provided for the different subsets of SSBs. In some cases, CORESET and RMSI allocations may be associated with SSBs in the first subset of SSBs 410 (e.g., CORESET #0/RMSI is only transmitted via narrow beams) and not SSBs of the second subset of SSBs 415. Such CORESET and RMSI allocations may be beneficial if downlink coverage is relatively poor for RMSI delivery, thus CORESET #0/RMSI may be transmitted via narrower and stronger beams. Such an allocation may be indicated by an identification of a preferred SSB in the first subset of SSBs 410. In other cases, CORESET and RMSI allocations may be associated with SSBs in the second subset of SSBs 415 and not SSBs of the first subset of SSBs 410, thus CORESET #0/RMSI may be transmitted via wider beams. Such allocations may be beneficial if downlink coverage is good enough for RMSI delivery, and may be indicated by a preferred SSB in the second subset of SSBs 415. In some cases, a preferred SSB identified in the first subset of SSBs can be used for RACH procedures (e.g., an enhanced Set-A narrower beam to provide better coverage/throughput for Msg1/2/3/4 or MsgA/B). In some aspects, a CORESET and RMSI allocation may be associated with SSBs from both the first subset of SSBs 410 and the second subset of SSBs 415 (e.g., CORESET #0/RMSI is transmitted via both sets of beams). In some aspects, whether CORESET or RMSI is presented for a certain SSB, is indicated by PSS sequence, or SSS sequence, or PBCH associated with the SSB (e.g., if PSS/SSS/PBCH is presented for the SSB). That is, CORESET #0/RMSI may be transmitted via beam(s) that are fully NW-implementation determined. For example, certain PSS or SSS sequences, or PBCH bit-points, may be defined that can provide such an indication. Such examples may allow for network flexibility to balance among energy consumption, efficiency, overhead, and UE-specific initial access performance.

In some aspects, RACH resources (e.g., RO/Preamble/PO) may be associated with one or more SSBs. In some examples, RACH resources may be associated only with SSBs in the first subset of SSBs 410. That is, receive and transmit beams for random access messages (e.g., Msg1/2/3/4 or MsgA/B) may be determined based on narrower beams of the first subset of SSBs 410. In other examples, RACH resources may be associated with only SSBs in the second subset of SSBs 415. That is, receive and transmit beams for random access messages (e.g., Msg1/2/3/4 or MsgA/B) may be determined based on wider beams of the second subset of SSBs 415. In other examples, RACH resources may be associated with SSBs from both the first subset of SSBs 410 and the second subset of SSBs 415. That is, receive and transmit beams for random access messages (e.g., Msg1/2/3/4 or MsgA/B) may should be determined based on narrower beams or wider beams. Such associations may provide flexibility, but consume redundant overhead network-side energy. In other examples, RMSI may indicate presence of RACH resources for SSBs. In such examples, one or more beams associated with RACH resources may be fully determined by the network, which may allow flexibility to balance among network energy consumption, efficiency, overhead, and UE-specific initial access performance.

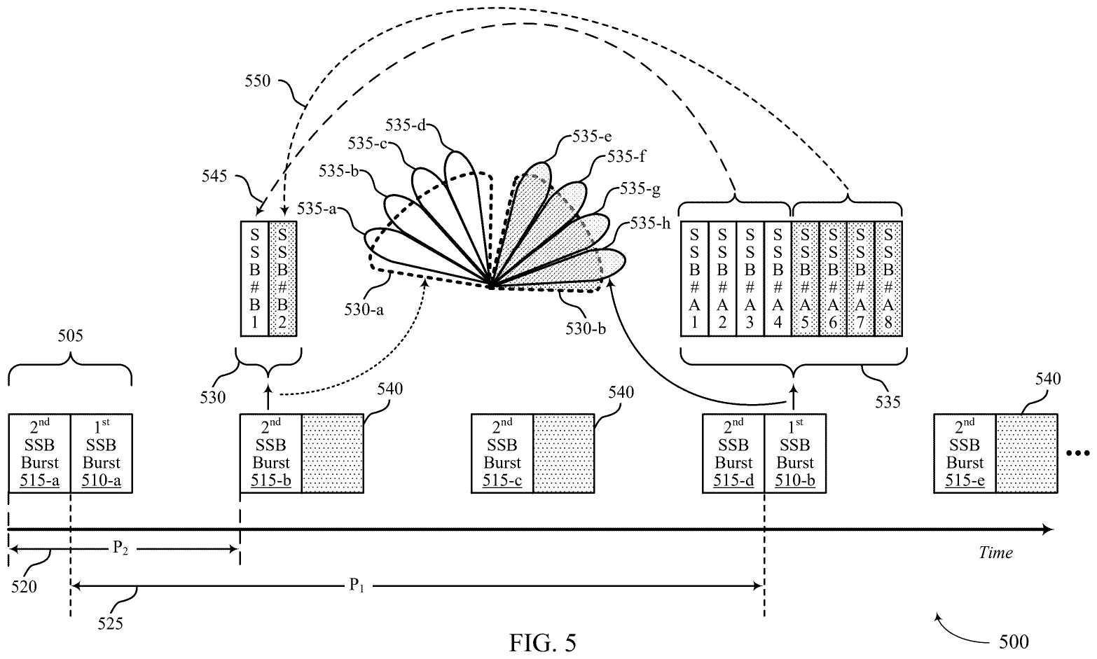

FIG. 5 shows an example of a SSB burst scheme 500 that supports spatial beam prediction for dual-cycle SSB bursts in accordance with one or more aspects of the present disclosure. In some examples, aspects of the SSB burst scheme 500 may implement, or be implemented by, aspects of the wireless communications systems 100 or 200, the SSB burst schemes 300 or 400, or any combination thereof. In particular, the SSB burst scheme 500 illustrates various implementations for dual-cycle SSB bursts in which a device that receives SSB transmission (e.g., a UE) may perform beam prediction for beams that are not transmitted in some SSB burst locations, as described herein.

Similarly as discussed in the examples of FIGS. 3 and 4, in this example periodic SSB bursts 505 may be configured in which a first subset of SSBs 510 and a second subset of SSBs 515 may be transmitted. In this example, the first subset of SSBs 510 may have a periodicity of P1 520 (e.g., 60 ms), and the second subset of SSBs 515 may have a periodicity of P2 525 (e.g., 20 ms), where P1/P2 is an integer value of greater than or equal to two. In this example, a first instance of the first subset of SSBs 510-a may be transmitted in a same SSB burst 505 as a first instance of the second subset of SSBs 515-a. A second instance of the second subset of SSBs 515-b and a third instance of the second subset of SSBs 515-c may also be transmitted in subsequent SSB bursts that do not include SSBs of the first subset of SSBs 510. In accordance with the indicated periodicities, a second instance of the first subset of SSBs 510-b may be transmitted with a fourth instance of the second subset of SSBs 515-d, and then a fifth instance of the second subset of SSBs 515-e may be transmitted in a subsequent SSB burst that does not include SSBs of the first subset of SSBs 510. As in FIG. 3, the second subset of SSBs 515 may include wide beam SSBs 530 (e.g., wide beam SSB #B1 530-a and wide beam SSB #B2 530-b), and the first subset of SSBs 510 may include narrow beam SSBs 535 (e.g., including narrow beam SSB #A1 535-a through narrow beam SSB #A8 535-h). In some aspects, a UE may measure transmitted SSBs in each SSB burst 505, and in cases where the first subset of SSBs 510 are not transmitted, may generate predictions 540 of corresponding measurement values (e.g., predicted L1-RSRP values based on measured L1-RSRP values).

In the example of FIG. 5, options for correspondence between beams of the first subset of SSBs 510 and the second subset of SSBs 515 may be provided. In some cases, certain beams of the first subset of SSBs 510 may be associated with a certain beam of the second subset of SSBs 515 (e.g., may be “children” or narrower beams of a certain “parent” or wider beam), and thus they can be QCL′d with the wider beam of the second subset of SSBs 515. For RRC-Connected mode, such QCL information can be RRC configured or indicated in a medium access control-control element (MAC-CE). However, for initial access, such information may be predefined or identified by the network through some indication from PSS, SSS, or PBCH associated with the SSBs in the second subset of SSBs 515. In such cases, the UE may carry out receive-beam sweeping for beams of the second subset of SSBs 515, and may not carry out receive-beam sweeping dedicated for beams of the first subset of SSBs 510. That is, the receive and transmit beams associated with the first subset of SSBs 510 for random access messages may be determined based on the receive and transmit beams identified from their TypeD-QCL'd beams of the second subset of SSBs 515.

In some aspects, predefined temporal locations of SSBs may be provided for the first subset of SSBs 510 and the second subset of SSBs 515, within a single cycle associated with the first and second subsets of SSBs. For example, for SSBs in the second subset of SSBs 515, at every 20 ms, symbols that may be transmitted by corresponding SSBs is predefined; and for SSBs in the first subset of SSBs 510, at every 60 ms, symbols that may be transmitted by corresponding SSBs is predefined. In some aspects, there may be predefined QCL relationships between SSBs in the first subset of SSBs 510 and the second subset of SSBs 515. In such aspects, for an SSB in the second subset of SSBs 515, identified based on its temporal location, one or more SSBs of the first subset of SSBs 510 may be defined (also identified based on their temporal location) as QCL′d therewith. In some cases, applicable QCL types may also be defined (e.g., only QCL-TypeD is applicable while QCL-TypeA/B/C are not). In the example, of FIG. 5, SSB #A1 535-a through SSB #A4 535-d may be QCL′d 545 with SSB #B1 530-a. Likewise, SSB #A5 535-e through SSB #A8 535-h may be QCL′d 550 with SSB #B2 530-b. In some examples, two or more SSBs identified based on their sequential temporal presence in the same cycle associated with the first subset of SSBs 510 may be respectively QCL′d with sequential SSBs of the second subset of SSBs 515 based on their sequential temporal presence in the same cycle. In other examples, PSS, SSS, and PBCH of SSBs in the second subset of SSBs 515 may indicate QCL′d SSBs in the first subset of SSBs 510. For example, for an SSB in the second subset of SSBs 515, its PSS or SSS sequence, or PBCH, may indicate which SSBs in the first subset of SSBs 510, identified based on their temporal location, are QCL′d therewith. In some cases, applicable QCL-types may be defined, while remaining QCL types may be measured at the UE (e.g., only QCL-TypeD is network indicatable while QCL-TypeA/B/C are not).

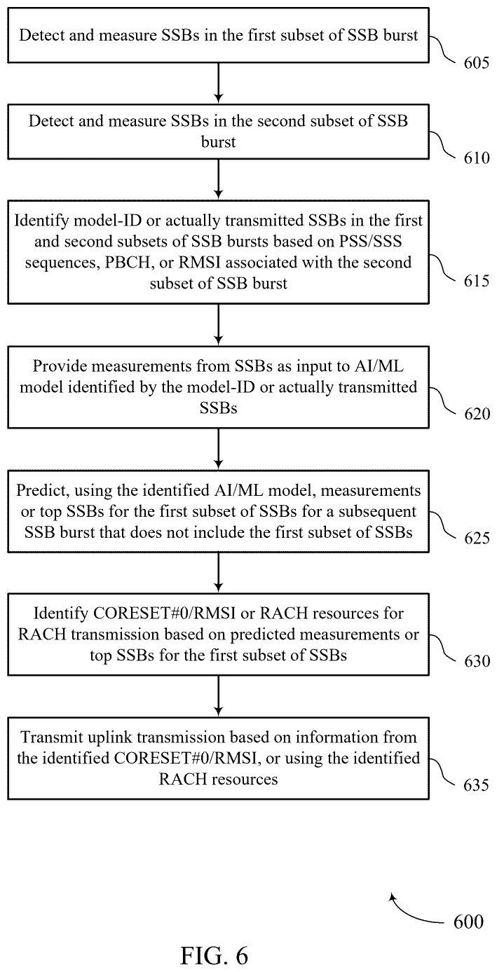

FIG. 6 shows an example of a flowchart illustrating a method 600 for identification of AI/ML models that supports spatial beam prediction for dual-cycle SSB bursts in accordance with one or more aspects of the present disclosure. The operations of the method 600 may be implemented by a UE or its components as described herein. For example, the operations of the method 600 may be performed by a UE 115 as described herein. In some examples, a UE may execute a set of instructions to control the functional elements of the UE to perform the described functions. Additionally, or alternatively, the UE may perform aspects of the described functions using special-purpose hardware. In some examples, aspects of the method 600 may implement, or be implemented by, aspects of the wireless communications systems 100 or 200, the SSB burst schemes 300, 400, or 500, or any combination thereof. In particular, the method 600 illustrates various implementations for dual-cycle SSB bursts in which a device that receives SSB transmission (e.g., a UE) may perform beam prediction for beams that are not transmitted in some SSB burst locations, as described herein.

In this example, at 605, the UE may detect and measure SSBs in a first subset of an SSB burst. At 610, the UE may detect and measure SSBs in the second subset of the SSB burst. As discussed herein, the first and second subsets of the SSB burst may have SSBs that are transmitted at different periodicities.

At 615, the UE may identify a model-ID or actually transmitted SSBs in the first and second subsets of SSB bursts based on PSS/SSS sequences, PBCH, or RMSI associated with the second subset of SSB burst. In some aspects, model-ID(s) or actually transmitted SSBs in the first subset of SSB bursts may be signaled via PSS, SSS, PBCH, RMSI, or any combination thereof, associated with the second subset of SSB bursts. For example, PSS, or SSS sequences, or PBCH, or RMSI, associated with the SSBs in the second subset of SSB bursts, may indicate model-ID(s) or actually transmitted SSBs in the first and second subsets of SSB bursts. In some aspects, the UE may be preloaded with candidate models associated with different geographical coordinates or zones; and the UE may select the appropriate model for prediction tasks based on geographical coordinates or zones identified at the time where initial access is carried out. In other aspects, the model may be selected at the UE based on measurements. For example, an AI/ML model whose input include L1-RSRPs of all potential SSBs associated with the first and second subsets of SSB bursts at their expected occasions may be used for the prediction problem, where non-transmitted SSBs may be received with extremely low L1-RSRP values. In some cases, the AI/ML model input may also include receive beam IDs used for measuring the respective SSBs.

At 620, the UE may provide measurements from SSBs as input to the AI/ML model identified by the model-ID or actually transmitted SSBs. At 625, the UE may predict, using the identified AI/ML model, measurements or top SSBs for the first subset of SSBs for a subsequent SSB burst that does not include the first subset of SSBs. In some cases, if one or more model-IDs are signaled, the corresponding model input (e.g., measured L1-RSRPs of actually transmitted SSBs in the SSB bursts at their expected presence occasions) and output (e.g., predicted L1-RSRPs of SSBs in the first subset of SSB bursts corresponding to their non-transmitted locations) definitions may be predefined. In some cases, if actually transmitted SSBs in the first and second subsets of SSB bursts are signaled, the UE may select one or more appropriate models matching with the actually transmitted SSBs (e.g., with input being L1-RSRPs based on the actually transmitted SSBs in the first and second subsets of SSB bursts, and the output being predicted L1-RSRPs of SSBs in the first subset of SSB bursts corresponding to their prediction occasions in which SSBs are not transmitted). In some cases, the UE may first detect and measure SSBs in the second subset of SSB bursts and decode PBCH or RMSI, so the relevant information can be identified, and then an appropriate model can be determined accordingly.

At 630, based on the model output, the UE may identify CORESET, RMSI, or RACH resources for RACH transmission based on predicted measurements or top SSBs for the first subset of SSBs. At 635, the UE may transmit uplink transmission based on information from the identified CORESET or RMSI, or using the identified RACH resources.

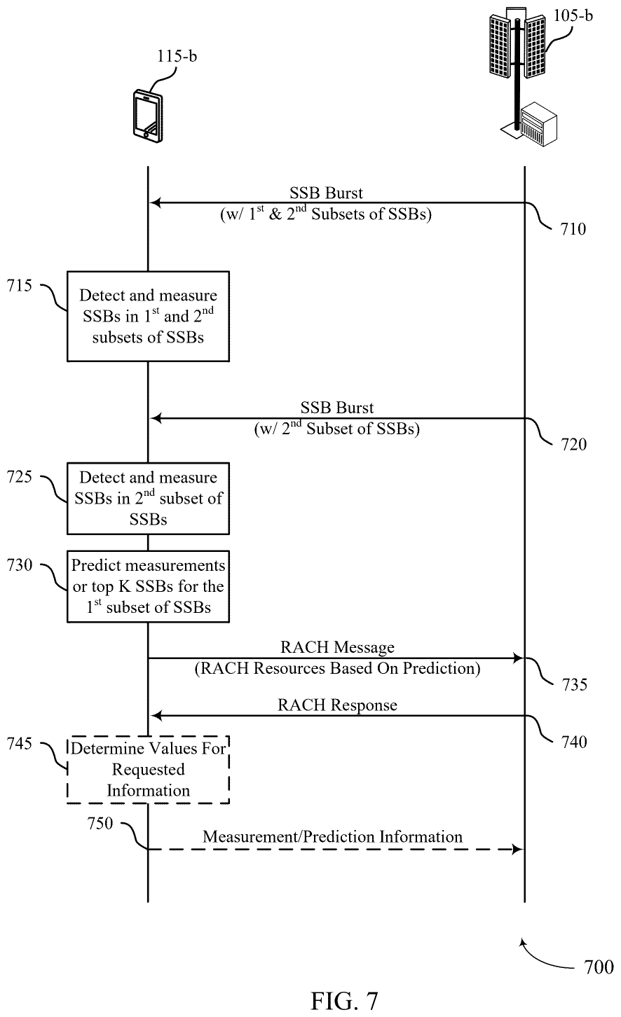

FIG. 7 shows an example of a process flow 700 that supports spatial beam prediction for dual-cycle SSB bursts in accordance with one or more aspects of the present disclosure. In some examples, aspects of the process flow 700 may implement, or be implemented by, aspects of the wireless communications systems 100 or 200, the SSB burst schemes 300, 400, or 500, the method 600, or any combination thereof. In particular, the process flow 700 illustrates various implementations for dual-cycle SSB bursts in which a device that receives SSB transmission (e.g., a UE) may perform beam prediction for beams that are not transmitted in some SSB burst locations, as described herein.

The process flow 700 includes a UE 115-b and a network entity 105-b, which may be examples of wireless devices as described herein. For example, the UE 115-b and the network entity 105-b illustrated in FIG. 7 may include examples of the UE 115-a and the network entity 105-a, respectively, as illustrated in FIG. 2. In this regard, the UE 115-b may be an example of a UE 115 that is capable of predicting one or more values for SSBs for one or more subsets of SSBs.

In some examples, the operations illustrated in process flow 700 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 710, the network entity 105-b may transmit, and the UE 115-b may receive, a first instance of an SSB burst. The first instance of the SSB burst may include, for example, first and second subsets of SSBs, where the first subset of SSBs are transmitted using relatively narrow beams and the second subset of SSBs are transmitted using relatively wide beams.

At 715, the UE may detect and measure the SSBs in the first and second subsets of SSBs. In some cases, the UE may measure RSRP values associated with each SSB of the first and second subsets of SSBs.

At 720, the network entity 105-b may transmit, and the UE 115-b may receive, a second instance of an SSB burst. The second instance of the SSB burst may include, for example, a second instance of the second subset of SSBs, and not any instances of SSBs of the first subset of SSBs.

At 725, the UE 115-b may detect and measure the SSBs in the second instance of the second subset of SSBs. In some cases, the UE may measure RSRP values associated with each SSB of the second subset of SSBs. At 730, the UE 115-b may predict measurements or a number of top SSBs (e.g., the top-K-SSBs) for the first subset of SSBs, where the predicted measurements correspond to a temporal location associated with the second instance of the second subset of SSBs. In some aspects, the UE 115-b may identify RACH resources for a random access message based at least in part on the predicted measurements.

At 735, the UE 115-b may transmit, and the network entity 105-b may receive, the RACH message using the identified RACH resources. At 740, the network entity 105-b may transmit, and the UE 115-b may receive, a RACH response.

Optionally, at 745, the UE 115-b may determine one or more values for information requested from the network entity 105-b. For example, the network entity 105-b may request (e.g., in a random access response) a model ID associated with a measurement prediction, one or more predicted measurement values, and the like. At 750, the UE 115-b may transmit, and the network entity 105-b may receive, the requested measurement or prediction information.

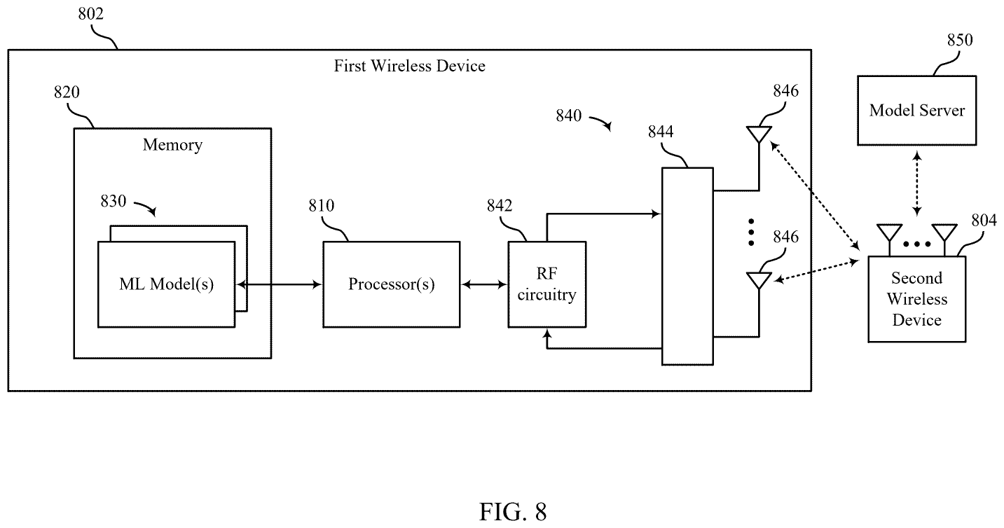

FIG. 8 shows an example of a block diagram of an example ML architecture 800 that supports spatial beam prediction for dual-cycle SSB bursts in accordance with one or more aspects of the present disclosure. In some examples, aspects of the ML architecture 800 may implement, or be implemented by, aspects of the wireless communications systems 100 or 200, the SSB burst schemes 300, 400, or 500, the method 600, the process flow 700, or any combination thereof. In particular, the ML architecture 800 illustrates various implementations for dual-cycle SSB bursts in which a device that receives SSB transmission (e.g., a UE) may perform beam prediction for beams that are not transmitted in some SSB burst locations, as described herein.

In the example of FIG. 8 a first wireless device 802 may be in communication with second wireless device 804. First wireless device 802 may be configured for dual-cycle SSB bursts and may perform beam prediction for beams that are not transmitted in some SSB burst locations. Similarly, the second wireless device may be configured for configured for dual-cycle SSB bursts and may transmit SSB bursts with different beams as discussed herein. Note that the example ML architecture of first wireless device 802 may be applied to second wireless device 804, and vice versa.

First wireless device 802 may be, or may include, a chip, system on chip (SoC), chipset, package or device that includes one or more processors, processing blocks or processing elements (collectively “processor 810”) and one or more memory blocks or elements (collectively “memory 820”). Processor 810 may be coupled to transceiver 840, which includes radio frequency (RF) circuitry 842 coupled to antennas 846 via interface 844, for transmitting or receiving signals.

One or more ML models 830 (collectively “ML model 830”) may be stored in memory 820 and accessible to processor(s) 810. Individual or groups of ML models 830 may be associated with respective model identifiers. In some aspects, different ML models 830, which may optionally be associated with different model identifiers, may have different characteristics. One or more ML models 830 may be selected based on respective features, characteristics, or applications, as well as characteristics or conditions of first wireless device 802 (such as, signaled model ID, an identification of actually transmitted SSBs, a location of the first wireless device, a mobility state, etc.). For example, ML models 830 may have different inference data and output pairings (such as, different types of inference data produce different types of output), different levels of accuracies associated with the predictions, different latencies associated with producing the predictions, different ML model sizes, different coefficients, different parameters, etc.

Processor 810 may deploy ML models 830 to produce respective output data based on input data. As an example, the ML model 830 may take measurements of one or more signals in a SSB (such as, corresponding to a wide beam or a narrow beam) as input to predict a channel characteristic associated with a different SSB burst in which a SSB is not transmitted (such as, corresponding to a narrow beam associated with a subsequent SSB burst, another wide beam, a narrow beam outside the wide beam, etc.). The input data may include, for example, measurements of one or more reference or synchronization signals, such as a channel quality metric, a RSRP, a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received quality (RSRQ), and/or a block error rate (BLER). The output data may include, for example, a predicted measurement of the corresponding channel characteristics.

In some aspects, model server 850 may perform various ML management tasks for first wireless device 802 and/or second wireless device 804. For example, model server 850 may host various types and/or versions of ML models 830 for first wireless device 802 and/or second wireless device 804 to download. Model server 850 may monitor and evaluate the performance of ML model 830. Model server 850 may transmit signals or provide indications/instructions to activate or deactivate the use of a particular ML model at first wireless device 802 or second wireless device 804. Model server 850 may switch to a different ML model 830 being used at first wireless device 802 or second wireless device 804, and model server 850 may provide such an instruction to the respective first wireless device 802 or second wireless device 804. Model server 850 may operate as a model training host (such as model training host B02) and update ML model 830 using training data. In some cases, the model server 850 may operate as a data source (such as data source B06) to collect and host training data, inference data, performance feedback, etc., associated with ML model 830.

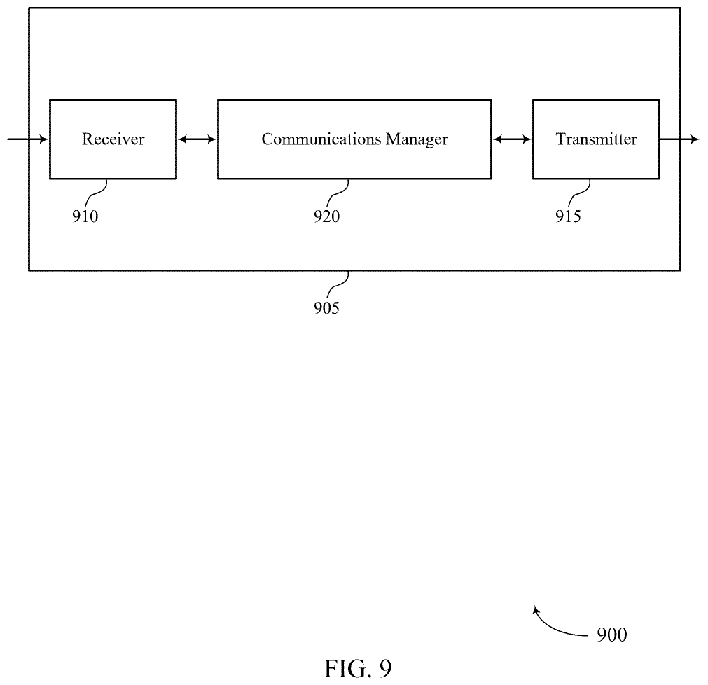

FIG. 9 shows a block diagram 900 of a device 905 that supports spatial beam prediction for dual-cycle SSB bursts in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to spatial beam prediction for dual-cycle SSB bursts). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to spatial beam prediction for dual-cycle SSB bursts). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of spatial beam prediction for dual-cycle SSB bursts as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for obtaining a set of measured reference signal values from one or more reference signals of a first subset of SSBs in a first SSB burst and one or more reference signals of a second subset of SSBs in a second SSB burst, where the first SSB burst and the second SSB burst are transmitted in a first set of wireless resources, and the first subset of SSBs is transmitted using a different set of transmit spatial filters than the second subset of SSBs. The communications manager 920 is capable of, configured to, or operable to support a means for predicting one or more reference signal measurements for one or more SSBs of the first subset of SSBs for a second set of wireless resources to obtain a set of predicted reference signal values, where the first subset of SSBs is absent from the second set of wireless resources. The communications manager 920 is capable of, configured to, or operable to support a means for selecting one of a CORESET or a set of random access resources for a random access transmission based on the set of measured reference signal values and the set of predicted reference signal values.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for dual-cycle SSB bursts that provide for efficient selection of one or more beams for communications based on transmissions of both wide and narrow beams. Such techniques may enhance network efficiency, reliability, and throughput, and reduce power consumption, by allowing measurements and beam selection based on both wide and narrow beams. Such techniques also may provide for relatively small increases in overhead associated with the narrow beam transmissions due to such transmissions having a lower periodicity than wide beam transmissions.

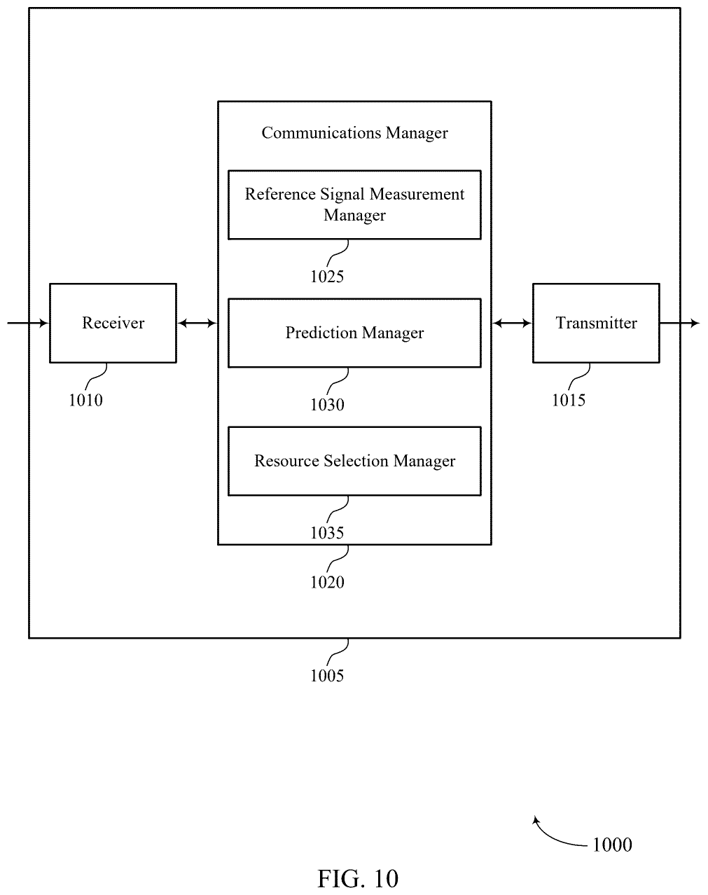

FIG. 10 shows a block diagram 1000 of a device 1005 that supports spatial beam prediction for dual-cycle SSB bursts in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to spatial beam prediction for dual-cycle SSB bursts). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to spatial beam prediction for dual-cycle SSB bursts). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of spatial beam prediction for dual-cycle SSB bursts as described herein. For example, the communications manager 1020 may include a reference signal measurement manager 1025, a prediction manager 1030, a resource selection manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The reference signal measurement manager 1025 is capable of, configured to, or operable to support a means for obtaining a set of measured reference signal values from one or more reference signals of a first subset of SSBs in a first SSB burst and one or more reference signals of a second subset of SSBs in a second SSB burst, where the first SSB burst and the second SSB burst are transmitted in a first set of wireless resources, and the first subset of SSBs is transmitted using a different set of transmit spatial filters than the second subset of SSBs. The prediction manager 1030 is capable of, configured to, or operable to support a means for predicting one or more reference signal measurements for one or more SSBs of the first subset of SSBs for a second set of wireless resources to obtain a set of predicted reference signal values, where the first subset of SSBs is absent from the second set of wireless resources. The resource selection manager 1035 is capable of, configured to, or operable to support a means for selecting one of a CORESET or a set of random access resources for a random access transmission based on the set of measured reference signal values and the set of predicted reference signal values.

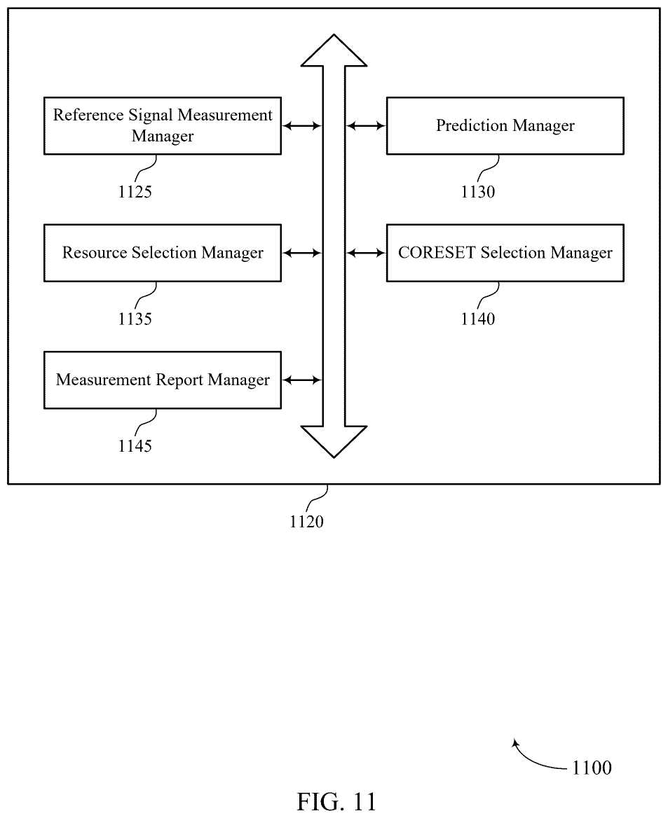

FIG. 11 shows a block diagram 1100 of a communications manager 1120 that supports spatial beam prediction for dual-cycle SSB bursts in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of spatial beam prediction for dual-cycle SSB bursts as described herein. For example, the communications manager 1120 may include a reference signal measurement manager 1125, a prediction manager 1130, a resource selection manager 1135, a CORESET selection manager 1140, a measurement report manager 1145, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The reference signal measurement manager 1125 is capable of, configured to, or operable to support a means for obtaining a set of measured reference signal values from one or more reference signals of a first subset of SSBs in a first SSB burst and one or more reference signals of a second subset of SSBs in a second SSB burst, where the first SSB burst and the second SSB burst are transmitted in a first set of wireless resources, and the first subset of SSBs is transmitted using a different set of transmit spatial filters than the second subset of SSBs. The prediction manager 1130 is capable of, configured to, or operable to support a means for predicting one or more reference signal measurements for one or more SSBs of the first subset of SSBs for a second set of wireless resources to obtain a set of predicted reference signal values, where the first subset of SSBs is absent from the second set of wireless resources. The resource selection manager 1135 is capable of, configured to, or operable to support a means for selecting one of a CORESET or a set of random access resources for a random access transmission based on the set of measured reference signal values and the set of predicted reference signal values. In some examples, the first subset of SSBs are transmitted at a first periodicity and the second subset of SSBs are transmitted at a second periodicity, and where the first periodicity divided by the second periodicity is an integer value that is greater than or equal to 2.

In some examples, to support selecting one of the CORESET or the set of random access resource, the CORESET selection manager 1140 is capable of, configured to, or operable to support a means for selecting a first CORESET or a first random access resource associated with a first SSB of the first subset of SSBs or a first SSB of the second subset of SSBs, where the first SSB of the first subset of SSBs and the first SSB of second subset of SSBs is a same SSB or a different SSB, and where the first SSB of the first subset of SSBs or the first SSB of second subset of SSBs has a reference signal measurement value or a predicted reference signal value that indicates more favorable channel conditions than other reference signal measurement values or predicted reference signal values of other SSBs of the first subset of SSBs or the second subset of SSBs.

In some examples, the first subset of SSBs and the second subset of SSBs each include one or more SSBs having one or more symbol structures that include one or more combinations of a first quantity of symbols that include a PSS, a second quantity of symbols that include a SSS, and a third quantity of symbols that include a PBCH. In some examples, each SSB of both the first subset of SSBs and the second subset of SSBs has a same symbol structure. In some examples, each SSB of the second subset of SSBs includes one or more symbols that contain the PSS, and each SSB of the first subset of SSBs includes one or more symbols that contain the SSS and the PBCH. In some examples, each SSB of the second subset of SSBs has a symbol structure that includes the PSS, the SSS, and the PBCH. In some examples, each SSB of the first subset of SSBs has a symbol structure that includes only the PSS, only the SSS, or both the PSS and the SSS. In some examples, the CORESET, a RMSI communication, or both, are provided only via one or more beams associated with SSBs of the second subset of SSBs.

In some examples, the CORESET selection manager 1140 is capable of, configured to, or operable to support a means for selecting one or more beams to monitor for the CORESET, a RMSI communication, or both, based on the selected CORESET or random access resources, where the one or more beams to monitor are determined based on one or more of a sequence of a PSS, a sequence of a SSS, or an indication included in a PBCH, transmitted in a SSB associated with the selected CORESET or random access resources. In some examples, the set of random access resources for the random access transmission is selected from a set of multiple available sets of random access resources associated with only the first subset of SSBs. In some examples, the set of random access resources for the random access transmission are indicated by a RMSI transmission associated with a SSB that is selected based on the set of reference signal measurement values and the predicted reference signal measurement values of the first subset of SSBs. In some examples, the first set of wireless resources include a first set of temporal locations within a single cycle associated with the first SSB burst and the second SSB burst, and where a first set of transmit spatial filters of the first subset of SSBs at a first temporal location of the first set of temporal locations have a predefined QCL relationship to a second set of transmit spatial filters of the second subset of SSBs at a second temporal location of the first set of temporal locations. In some examples, the first set of wireless resources include a first set of temporal locations within a single cycle associated with the first SSB burst and the second SSB burst, and where a first set of transmit spatial filters of the first subset of SSBs are indicated by one or more of a synchronization signal sequence or an indicator of a PBCH of one or more SSBs of the second subset of SSBs.

In some examples, the prediction manager 1130 is capable of, configured to, or operable to support a means for selecting an artificial intelligence model for predicting the one or more reference signal measurements based on a model ID or an identification of transmitted SSBs in the first subset of SSBs that is provided in the second subset of SSBs. In some examples, the prediction manager 1130 is capable of, configured to, or operable to support a means for selecting an artificial intelligence model for predicting the one or more reference signal measurements based on a geographical location of the UE and a set of candidate models associated with different geographical locations. In some examples, the prediction manager 1130 is capable of, configured to, or operable to support a means for selecting an artificial intelligence model for predicting the one or more reference signal measurements based on the measured reference signal values of the first subset of SSBs and second subsets of SSBs.

In some examples, the measurement report manager 1145 is capable of, configured to, or operable to support a means for receiving a scheduling message that indicates that a measurement report is to be transmitted that includes at least a portion of the set of predicted reference signal values. In some examples, at least the portion of the set of predicted reference signal values is provided in the measurement report when a reporting periodicity of the measurement report is shorter than a transmission periodicity of the first subset of SSBs. In some examples, at least a portion of the set of measured reference signal values is provided in the measurement report in response to a trigger for an aperiodic measurement report when a timer associated with corresponding measurements is unexpired, and at least the portion of the set of predicted reference signal values is provided in the response to the trigger when the timer associated with the corresponding measurements is expired, and where a duration of the timer corresponds to a periodicity of the second subset of SSBs.

In some examples, a bandwidth, a quantity of physical resource blocks, a quantity of resource elements, or any combination thereof, of the first subset of SSBs is the same or different than the second subset of SSBs, and where the first subset of SSBs has a same quantity or a different quantity of transmit spatial filters as the second subset of SSBs.

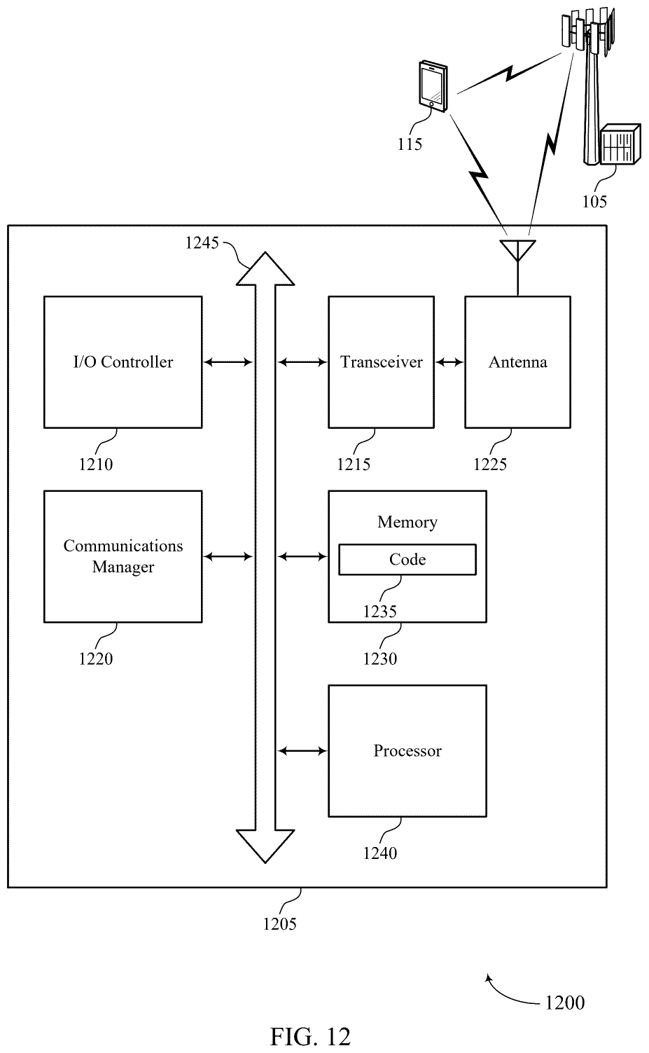

FIG. 12 shows a diagram of a system 1200 including a device 1205 that supports spatial beam prediction for dual-cycle SSB bursts in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting spatial beam prediction for dual-cycle SSB bursts). For example, the device 1205 or a component of the device 1205 may include at least one processor 1240 and at least one memory 1230 coupled with or to the at least one processor 1240, the at least one processor 1240 and the at least one memory 1230 configured to perform various functions described herein. In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for obtaining a set of measured reference signal values from one or more reference signals of a first subset of SSBs in a first SSB burst and one or more reference signals of a second subset of SSBs in a second SSB burst, where the first SSB burst and the second SSB burst are transmitted in a first set of wireless resources, and the first subset of SSBs is transmitted using a different set of transmit spatial filters than the second subset of SSBs. The communications manager 1220 is capable of, configured to, or operable to support a means for predicting one or more reference signal measurements for one or more SSBs of the first subset of SSBs for a second set of wireless resources to obtain a set of predicted reference signal values, where the first subset of SSBs is absent from the second set of wireless resources. The communications manager 1220 is capable of, configured to, or operable to support a means for selecting one of a CORESET or a set of random access resources for a random access transmission based on the set of measured reference signal values and the set of predicted reference signal values.

By including or configuring the communications manager 1220 in accordance with examples as described herein, the device 1205 may support techniques for dual-cycle SSB bursts that provide for efficient selection of one or more beams for communications based on transmissions of both wide and narrow beams. Such techniques may enhance network efficiency, reliability, and throughput, and reduce power consumption, by allowing measurements and beam selection based on both wide and narrow beams. Such techniques also may provide for relatively small increases in overhead associated with the narrow beam transmissions due to such transmissions having a lower periodicity than wide beam transmissions.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of spatial beam prediction for dual-cycle SSB bursts as described herein, or the at least one processor 1240 and the at least one memory 1230 may be otherwise configured to, individually or collectively, perform or support such operations.

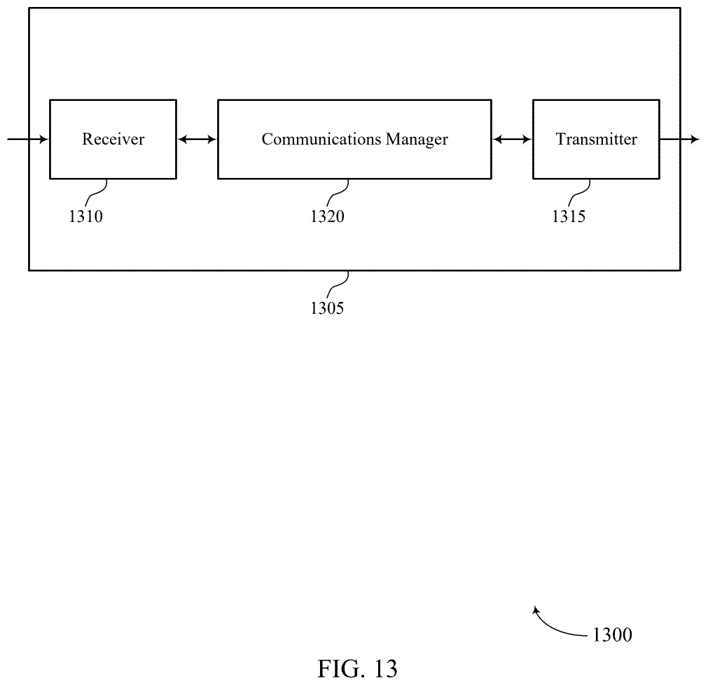

FIG. 13 shows a block diagram 1300 of a device 1305 that supports spatial beam prediction for dual-cycle SSB bursts in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of spatial beam prediction for dual-cycle SSB bursts as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for configuring a UE to obtain a set of measured reference signal values and a set of predicted reference signal values, where the set of measured reference signal values is configured to be obtained from one or more reference signals of a first subset of SSBs in a first SSB burst and one or more reference signals of a second subset of SSBs in a second SSB burst, the first SSB burst and the second SSB burst transmitted in a first set of wireless resources, and where the set of predicted reference signal values is configured to be obtained for the first subset of SSBs for a second set of wireless resources in which the first subset of SSBs is absent. The communications manager 1320 is capable of, configured to, or operable to support a means for transmitting, in the first set of wireless resources, one or more reference signals of the first subset of SSBs in a first instance of the first SSB burst and one or more reference signals of the second subset of SSBs in a first instance of the second SSB burst, where the first subset of SSBs is transmitted using a different set of transmit spatial filters than the second subset of SSBs. The communications manager 1320 is capable of, configured to, or operable to support a means for transmitting, in the second set of wireless resources, one or more reference signals of the second subset of SSBs in a second instance of the second SSB burst. The communications manager 1320 is capable of, configured to, or operable to support a means for receiving a random access message from the UE in a set of random access resources, where the set of random access resources is associated with at least one SSB of the first subset of SSBs or the second subset of SSBs.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for dual-cycle SSB bursts that provide for efficient selection of one or more beams for communications based on transmissions of both wide and narrow beams. Such techniques may enhance network efficiency, reliability, and throughput, and reduce power consumption, by allowing measurements and beam selection based on both wide and narrow beams. Such techniques also may provide for relatively small increases in overhead associated with the narrow beam transmissions due to such transmissions having a lower periodicity than wide beam transmissions.

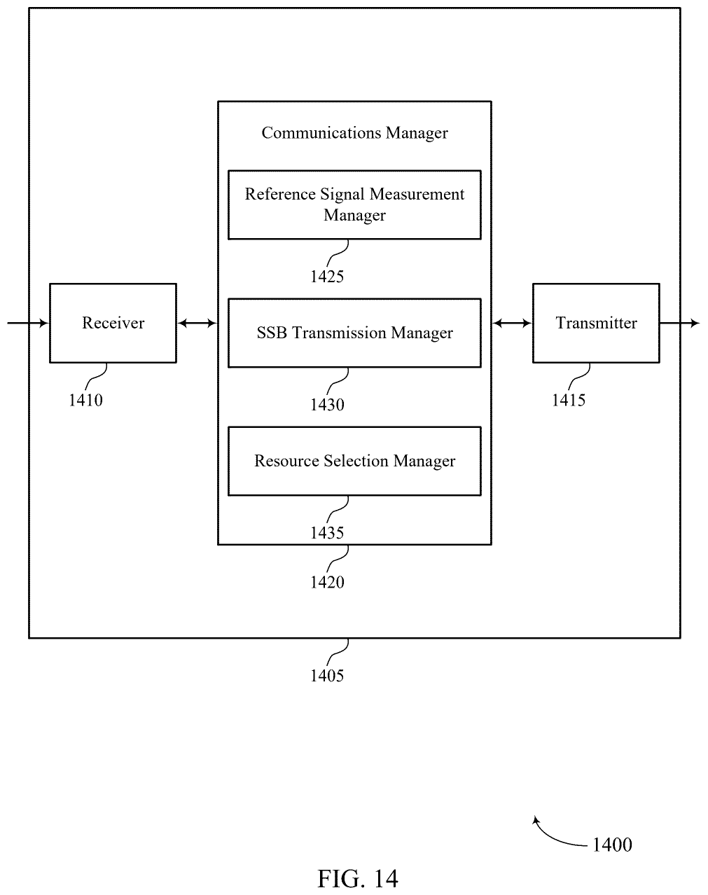

FIG. 14 shows a block diagram 1400 of a device 1405 that supports spatial beam prediction for dual-cycle SSB bursts in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one of more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of spatial beam prediction for dual-cycle SSB bursts as described herein. For example, the communications manager 1420 may include a reference signal measurement manager 1425, an SSB transmission manager 1430, a resource selection manager 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The reference signal measurement manager 1425 is capable of, configured to, or operable to support a means for configuring a UE to obtain a set of measured reference signal values and a set of predicted reference signal values, where the set of measured reference signal values is configured to be obtained from one or more reference signals of a first subset of SSBs in a first SSB burst and one or more reference signals of a second subset of SSBs in a second SSB burst, the first SSB burst and the second SSB burst transmitted in a first set of wireless resources, and where the set of predicted reference signal values is configured to be obtained for the first subset of SSBs for a second set of wireless resources in which the first subset of SSBs is absent. The SSB transmission manager 1430 is capable of, configured to, or operable to support a means for transmitting, in the first set of wireless resources, one or more reference signals of the first subset of SSBs in a first instance of the first SSB burst and one or more reference signals of the second subset of SSBs in a first instance of the second SSB burst, where the first subset of SSBs is transmitted using a different set of transmit spatial filters than the second subset of SSBs. The SSB transmission manager 1430 is capable of, configured to, or operable to support a means for transmitting, in the second set of wireless resources, one or more reference signals of the second subset of SSBs in a second instance of the second SSB burst. The resource selection manager 1435 is capable of, configured to, or operable to support a means for receiving a random access message from the UE in a set of random access resources, where the set of random access resources is associated with at least one SSB of the first subset of SSBs or the second subset of SSBs.

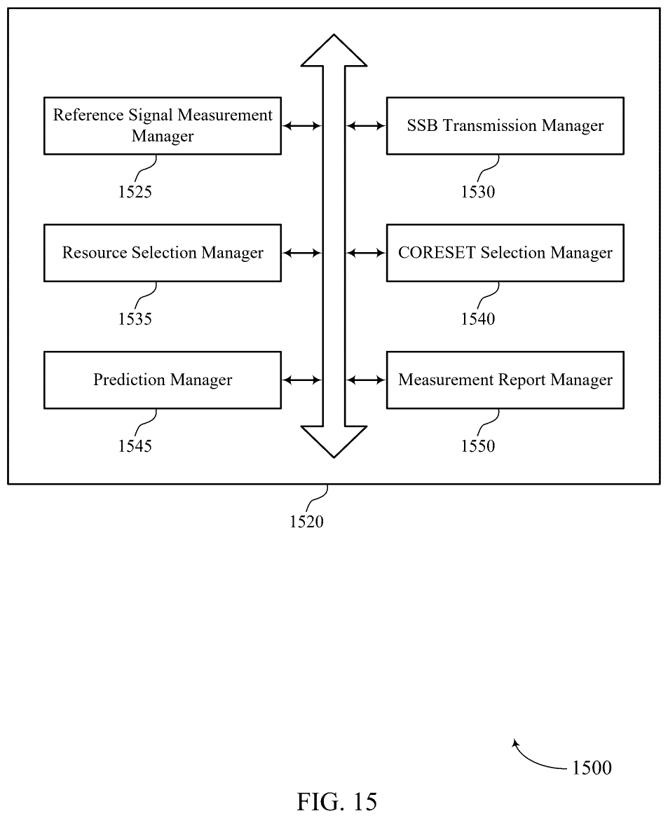

FIG. 15 shows a block diagram 1500 of a communications manager 1520 that supports spatial beam prediction for dual-cycle SSB bursts in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of spatial beam prediction for dual-cycle SSB bursts as described herein. For example, the communications manager 1520 may include a reference signal measurement manager 1525, an SSB transmission manager 1530, a resource selection manager 1535, a CORESET selection manager 1540, a prediction manager 1545, a measurement report manager 1550, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The reference signal measurement manager 1525 is capable of, configured to, or operable to support a means for configuring a UE to obtain a set of measured reference signal values and a set of predicted reference signal values, where the set of measured reference signal values is configured to be obtained from one or more reference signals of a first subset of SSBs in a first SSB burst and one or more reference signals of a second subset of SSBs in a second SSB burst, the first SSB burst and the second SSB burst transmitted in a first set of wireless resources, and where the set of predicted reference signal values is configured to be obtained for the first subset of SSBs for a second set of wireless resources in which the first subset of SSBs is absent. The SSB transmission manager 1530 is capable of, configured to, or operable to support a means for transmitting, in the first set of wireless resources, one or more reference signals of the first subset of SSBs in a first instance of the first SSB burst and one or more reference signals of the second subset of SSBs in a first instance of the second SSB burst, where the first subset of SSBs is transmitted using a different set of transmit spatial filters than the second subset of SSBs. In some examples, the SSB transmission manager 1530 is capable of, configured to, or operable to support a means for transmitting, in the second set of wireless resources, one or more reference signals of the second subset of SSBs in a second instance of the second SSB burst. The resource selection manager 1535 is capable of, configured to, or operable to support a means for receiving a random access message from the UE in a set of random access resources, where the set of random access resources is associated with at least one SSB of the first subset of SSBs or the second subset of SSBs. In some examples, the first subset of SSBs are transmitted at a first periodicity and the second subset of SSBs are transmitted at a second periodicity, and where the first periodicity divided by the second periodicity is an integer value that is greater than or equal to 2.

In some examples, to support configuring the UE, the resource selection manager 1535 is capable of, configured to, or operable to support a means for configuring the UE to select a first CORESET or a first random access resource associated with a first SSB of the first subset of SSBs or a first SSB of the second subset of SSBs, where the first SSB of the first subset of SSBs and the first SSB of second subset of SSBs is a same SSB or a different SSB, and where the first SSB of the first subset of SSBs or the first SSB of second subset of SSBs has a reference signal measurement value or a predicted reference signal value that indicates more favorable channel conditions than other reference signal measurement values or predicted reference signal values of other SSBs of the first subset of SSBs or the second subset of SSBs.

In some examples, the first subset of SSBs and the second subset of SSBs each include one or more SSBs having one or more symbol structures that include one or more combinations of a first quantity of symbols that include a PSS, a second quantity of symbols that include a SSS, and a third quantity of symbols that include a PBCH. In some examples, each SSB of both the first subset of SSBs and the second subset of SSBs has a same symbol structure. In some examples, each SSB of the second subset of SSBs includes one or more symbols that contain the PSS, and each SSB of the first subset of SSBs includes one or more symbols that contain the SSS and the PBCH. In some examples, each SSB of the second subset of SSBs has a symbol structure that includes the PSS, the SSS, and the PBCH. In some examples, each SSB of the first subset of SSBs has a symbol structure that includes only the PSS, only the SSS, or both the PSS and the SSS. In some examples, a CORESET, a RMSI communication, or both, are provided only via one or more beams associated with SSBs of the second subset of SSBs.

In some examples, the CORESET selection manager 1540 is capable of, configured to, or operable to support a means for transmitting a CORESET, a RMSI communication, or both, using at least a first beam that is indicated by one or more of a sequence of a PSS of one or more reference signal transmissions, a sequence of a SSS one or more reference signal transmissions, or an indication included in a PBCH of a SSB associated with the CORESET or random access resources. In some examples, the set of random access resources for the random access message is one of a set of multiple available sets of random access resources associated with only the first subset of SSBs. In some examples, the set of random access resources for the random access message are indicated by a RMSI transmission associated with a SSB that is selected by the UE based on the set of reference signal measurements and the predicted reference signal measurements of the first subset of SSBs. In some examples, the first set of wireless resources include a first set of temporal locations within a single cycle associated with the first SSB burst and the second SSB burst, and where a first set of transmit spatial filters of the first subset of SSBs at a first temporal location of the first set of temporal locations have a predefined QCL relationship to a second set of transmit spatial filters of the second subset of SSBs at a second temporal location of the first set of temporal locations. In some examples, the first set of wireless resources include a first set of temporal locations within a single cycle associated with the first SSB burst and the second SSB burst, and where a first set of transmit spatial filters of the first subset of SSBs are indicated by one or more of a synchronization signal sequence or an indicator of a PBCH of one or more SSBs of the second subset of SSBs.

In some examples, the prediction manager 1545 is capable of, configured to, or operable to support a means for providing an indication to the UE of an artificial intelligence model for predicting the set of predicted reference signal values based on a model ID or an identification of transmitted SSBs in the first subset of SSBs that is provided in the second subset of SSBs. In some examples, an artificial intelligence model for predicting the set of predicted reference signal values is identified based on a geographical location of the UE and a set of candidate models associated with different geographical locations. In some examples, an artificial intelligence model for predicting the set of predicted reference signal values is identified based on the measured reference signal values of the first subset of SSBs and second subsets of SSBs.

In some examples, the measurement report manager 1550 is capable of, configured to, or operable to support a means for transmitting a scheduling message to the UE that indicates that a measurement report is to be provided that includes at least a portion of the set of predicted reference signal values. In some examples, at least the portion of the set of predicted reference signal values is provided in the measurement report when a reporting periodicity of the measurement report is shorter than a transmission periodicity of the first subset of SSBs. In some examples, at least a portion of the set of measured reference signal values is provided in the measurement report in response to a trigger for an aperiodic measurement report when a timer associated with corresponding measurements is unexpired, and at least the portion of the set of predicted reference signal values is provided in the response to the trigger when the timer associated with the corresponding measurements is expired, and where a duration of the timer corresponds to a periodicity of the second subset of SSBs.

In some examples, a bandwidth, a quantity of physical resource blocks, a quantity of resource elements, or any combination thereof, of the first subset of SSBs is the same or different than the second subset of SSBs, and where the first subset of SSBs has a same quantity or a different quantity of transmit spatial filters as the second subset of SSBs.

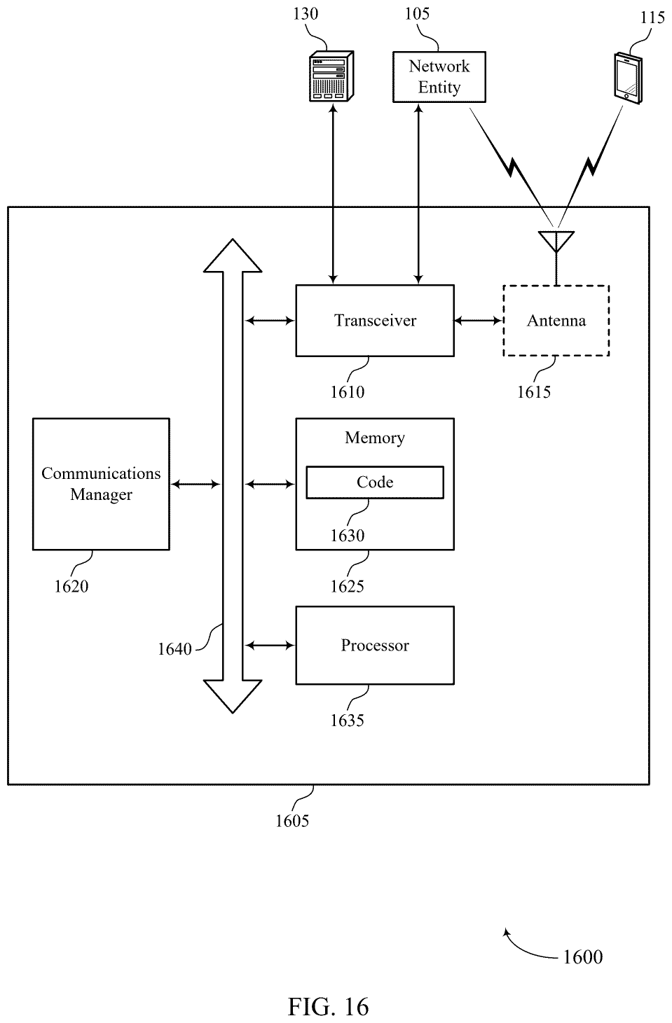

FIG. 16 shows a diagram of a system 1600 including a device 1605 that supports spatial beam prediction for dual-cycle SSB bursts in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting spatial beam prediction for dual-cycle SSB bursts). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625). In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network devices 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for configuring a UE to obtain a set of measured reference signal values and a set of predicted reference signal values, where the set of measured reference signal values is configured to be obtained from one or more reference signals of a first subset of SSBs in a first SSB burst and one or more reference signals of a second subset of SSBs in a second SSB burst, the first SSB burst and the second SSB burst transmitted in a first set of wireless resources, and where the set of predicted reference signal values is configured to be obtained for the first subset of SSBs for a second set of wireless resources in which the first subset of SSBs is absent. The communications manager 1620 is capable of, configured to, or operable to support a means for transmitting, in the first set of wireless resources, one or more reference signals of the first subset of SSBs in a first instance of the first SSB burst and one or more reference signals of the second subset of SSBs in a first instance of the second SSB burst, where the first subset of SSBs is transmitted using a different set of transmit spatial filters than the second subset of SSBs. The communications manager 1620 is capable of, configured to, or operable to support a means for transmitting, in the second set of wireless resources, one or more reference signals of the second subset of SSBs in a second instance of the second SSB burst. The communications manager 1620 is capable of, configured to, or operable to support a means for receiving a random access message from the UE in a set of random access resources, where the set of random access resources is associated with at least one SSB of the first subset of SSBs or the second subset of SSBs.

By including or configuring the communications manager 1620 in accordance with examples as described herein, the device 1605 may support techniques for dual-cycle SSB bursts that provide for efficient selection of one or more beams for communications based on transmissions of both wide and narrow beams. Such techniques may enhance network efficiency, reliability, and throughput, and reduce power consumption, by allowing measurements and beam selection based on both wide and narrow beams. Such techniques also may provide for relatively small increases in overhead associated with the narrow beam transmissions due to such transmissions having a lower periodicity than wide beam transmissions.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of spatial beam prediction for dual-cycle SSB bursts as described herein, or the at least one processor 1635 and the at least one memory 1625 may be otherwise configured to, individually or collectively, perform or support such operations.

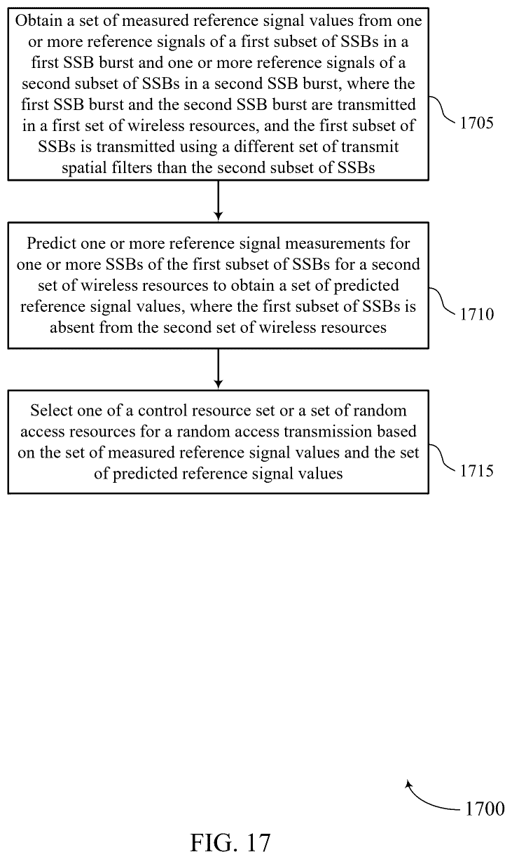

FIG. 17 shows a flowchart illustrating a method 1700 that supports spatial beam prediction for dual-cycle SSB bursts in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include obtaining a set of measured reference signal values from one or more reference signals of a first subset of SSBs in a first SSB burst and one or more reference signals of a second subset of SSBs in a second SSB burst, where the first SSB burst and the second SSB burst are transmitted in a first set of wireless resources, and the first subset of SSBs is transmitted using a different set of transmit spatial filters than the second subset of SSBs. The operations of 1705 may be performed in accordance with examples as disclosed herein. In some examples, aspects of the operations of 1705 may be performed by a reference signal measurement manager 1125 as described with reference to FIG. 11.

At 1710, the method may include predicting one or more reference signal measurements for one or more SSBs of the first subset of SSBs for a second set of wireless resources to obtain a set of predicted reference signal values, where the first subset of SSBs is absent from the second set of wireless resources. The operations of 1710 may be performed in accordance with examples as disclosed herein. In some examples, aspects of the operations of 1710 may be performed by a prediction manager 1130 as described with reference to FIG. 11.

At 1715, the method may include selecting one of a CORESET or a set of random access resources for a random access transmission based on the set of measured reference signal values and the set of predicted reference signal values. The operations of 1715 may be performed in accordance with examples as disclosed herein. In some examples, aspects of the operations of 1715 may be performed by a resource selection manager 1135 as described with reference to FIG. 11.

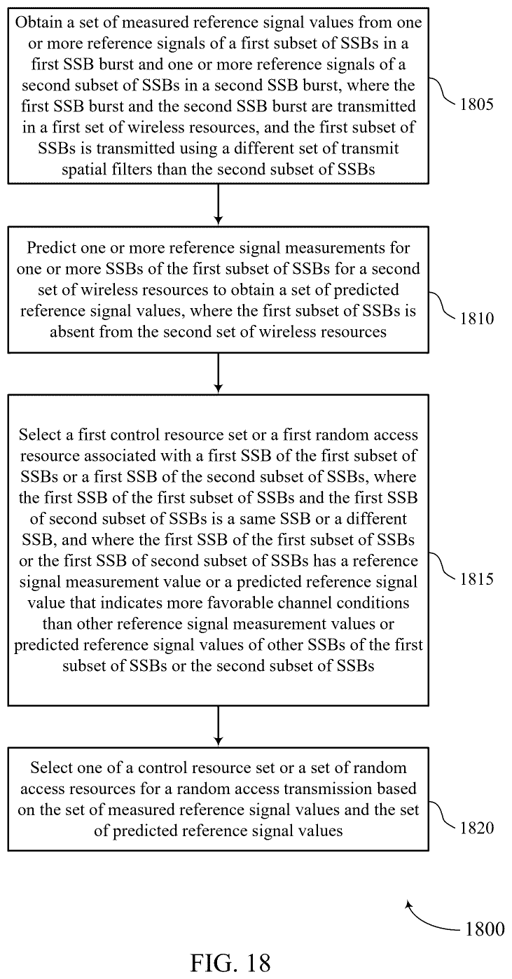

FIG. 18 shows a flowchart illustrating a method 1800 that supports spatial beam prediction for dual-cycle SSB bursts in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include obtaining a set of measured reference signal values from one or more reference signals of a first subset of SSBs in a first SSB burst and one or more reference signals of a second subset of SSBs in a second SSB burst, where the first SSB burst and the second SSB burst are transmitted in a first set of wireless resources, and the first subset of SSBs is transmitted using a different set of transmit spatial filters than the second subset of SSBs. The operations of 1805 may be performed in accordance with examples as disclosed herein. In some examples, aspects of the operations of 1805 may be performed by a reference signal measurement manager 1125 as described with reference to FIG. 11.

At 1810, the method may include predicting one or more reference signal measurements for one or more SSBs of the first subset of SSBs for a second set of wireless resources to obtain a set of predicted reference signal values, where the first subset of SSBs is absent from the second set of wireless resources. The operations of 1810 may be performed in accordance with examples as disclosed herein. In some examples, aspects of the operations of 1810 may be performed by a prediction manager 1130 as described with reference to FIG. 11.

At 1815, the method may include selecting a first CORESET or a first random access resource associated with a first SSB of the first subset of SSBs or a first SSB of the second subset of SSBs, where the first SSB of the first subset of SSBs and the first SSB of second subset of SSBs is a same SSB or a different SSB, and where the first SSB of the first subset of SSBs or the first SSB of second subset of SSBs has a reference signal measurement value or a predicted reference signal value that indicates more favorable channel conditions than other reference signal measurement values or predicted reference signal values of other SSBs of the first subset of SSBs or the second subset of SSBs. The operations of 1815 may be performed in accordance with examples as disclosed herein. In some examples, aspects of the operations of 1815 may be performed by a CORESET selection manager 1140 as described with reference to FIG. 11.

At 1820, the method may include selecting one of a CORESET or a set of random access resources for a random access transmission based on the set of measured reference signal values and the set of predicted reference signal values. The operations of 1820 may be performed in accordance with examples as disclosed herein. In some examples, aspects of the operations of 1820 may be performed by a resource selection manager 1135 as described with reference to FIG. 11.

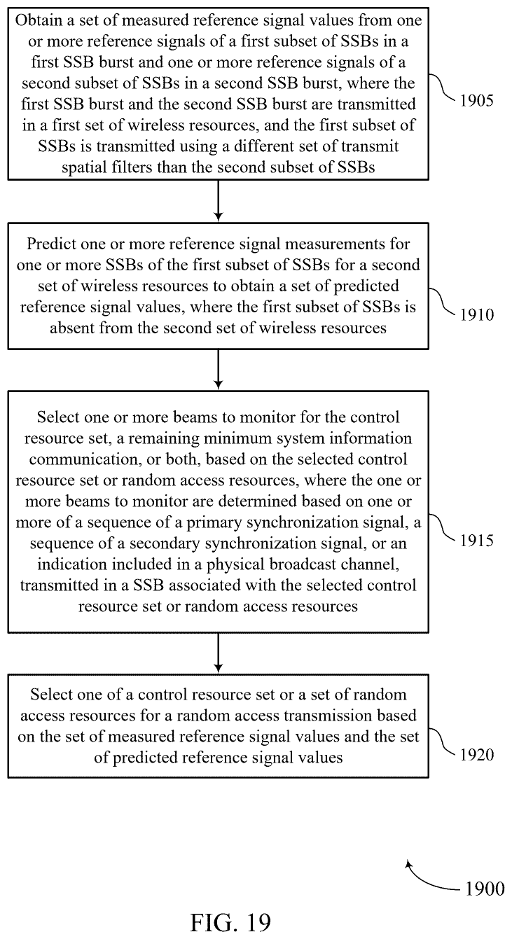

FIG. 19 shows a flowchart illustrating a method 1900 that supports spatial beam prediction for dual-cycle SSB bursts in accordance with one or more aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include obtaining a set of measured reference signal values from one or more reference signals of a first subset of SSBs in a first SSB burst and one or more reference signals of a second subset of SSBs in a second SSB burst, where the first SSB burst and the second SSB burst are transmitted in a first set of wireless resources, and the first subset of SSBs is transmitted using a different set of transmit spatial filters than the second subset of SSBs. The operations of 1905 may be performed in accordance with examples as disclosed herein. In some examples, aspects of the operations of 1905 may be performed by a reference signal measurement manager 1125 as described with reference to FIG. 11.

At 1910, the method may include predicting one or more reference signal measurements for one or more SSBs of the first subset of SSBs for a second set of wireless resources to obtain a set of predicted reference signal values, where the first subset of SSBs is absent from the second set of wireless resources. The operations of 1910 may be performed in accordance with examples as disclosed herein. In some examples, aspects of the operations of 1910 may be performed by a prediction manager 1130 as described with reference to FIG. 11.

At 1915, the method may include selecting one or more beams to monitor for the CORESET, a RMSI communication, or both, based on the selected CORESET or random access resources, where the one or more beams to monitor are determined based on one or more of a sequence of a PSS, a sequence of a SSS, or an indication included in a PBCH, transmitted in a SSB associated with the selected CORESET or random access resources. The operations of 1915 may be performed in accordance with examples as disclosed herein. In some examples, aspects of the operations of 1915 may be performed by a CORESET selection manager 1140 as described with reference to FIG. 11.

At 1920, the method may include selecting one of a CORESET or a set of random access resources for a random access transmission based on the set of measured reference signal values and the set of predicted reference signal values. The operations of 1920 may be performed in accordance with examples as disclosed herein. In some examples, aspects of the operations of 1920 may be performed by a resource selection manager 1135 as described with reference to FIG. 11.

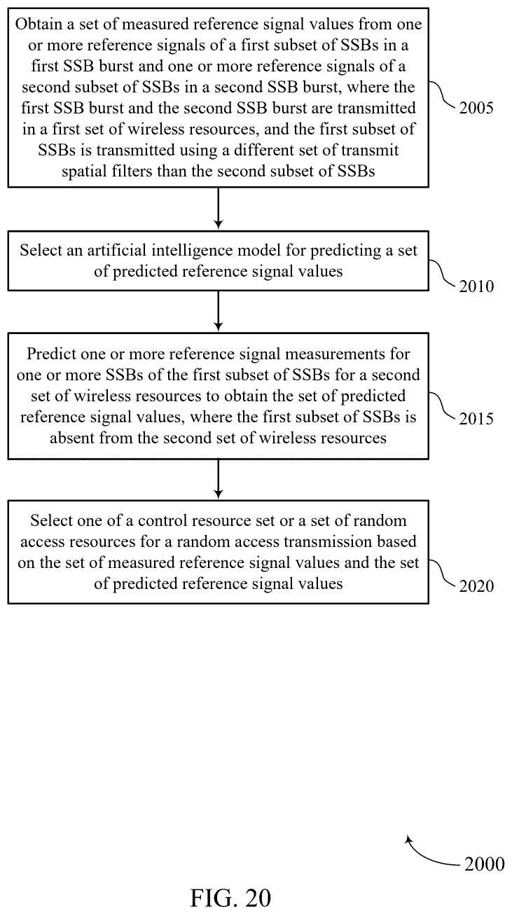

FIG. 20 shows a flowchart illustrating a method 2000 that supports spatial beam prediction for dual-cycle SSB bursts in accordance with one or more aspects of the present disclosure. The operations of the method 2000 may be implemented by a UE or its components as described herein. For example, the operations of the method 2000 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2005, the method may include obtaining a set of measured reference signal values from one or more reference signals of a first subset of SSBs in a first SSB burst and one or more reference signals of a second subset of SSBs in a second SSB burst, where the first SSB burst and the second SSB burst are transmitted in a first set of wireless resources, and the first subset of SSBs is transmitted using a different set of transmit spatial filters than the second subset of SSBs. The operations of 2005 may be performed in accordance with examples as disclosed herein. In some examples, aspects of the operations of 2005 may be performed by a reference signal measurement manager 1125 as described with reference to FIG. 11.

At 2010, the method may include selecting an artificial intelligence model for predicting the set of predicted reference signal values. The operations of 2015 may be performed in accordance with examples as disclosed herein. In some examples, aspects of the operations of 2015 may be performed by a prediction manager 1130 as described with reference to FIG. 11. In some examples, the artificial intelligence model may be selected based on a model ID or an identification of transmitted SSBs in the first subset of SSBs that is provided in the second subset of SSBs. In some examples, the artificial intelligence model may be selected based on a geographical location of the UE and a set of candidate models associated with different geographical locations. In some examples, the artificial intelligence model may be selected based on the measured reference signal values of the first subset of SSBs and second subsets of SSBs.

At 2015, the method may include predicting one or more reference signal measurements for one or more SSBs of the first subset of SSBs for a second set of wireless resources to obtain a set of predicted reference signal values, where the first subset of SSBs is absent from the second set of wireless resources. The operations of 2010 may be performed in accordance with examples as disclosed herein. In some examples, aspects of the operations of 2010 may be performed by a prediction manager 1130 as described with reference to FIG. 11.

At 2020, the method may include selecting one of a CORESET or a set of random access resources for a random access transmission based on the set of measured reference signal values and the set of predicted reference signal values. The operations of 2020 may be performed in accordance with examples as disclosed herein. In some examples, aspects of the operations of 2020 may be performed by a resource selection manager 1135 as described with reference to FIG. 11.

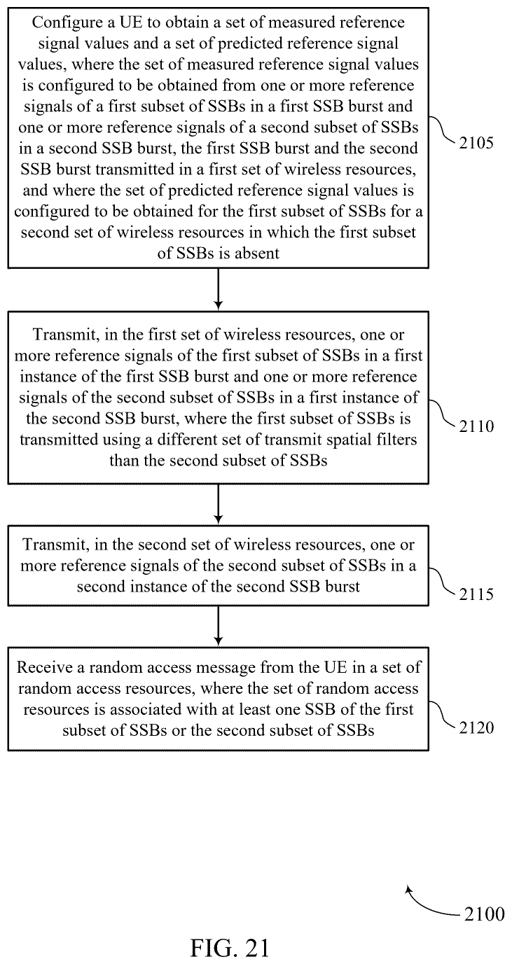

FIG. 21 shows a flowchart illustrating a method 2100 that supports spatial beam prediction for dual-cycle SSB bursts in accordance with one or more aspects of the present disclosure. The operations of the method 2100 may be implemented by a network entity or its components as described herein. For example, the operations of the method 2100 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2105, the method may include configuring a UE to obtain a set of measured reference signal values and a set of predicted reference signal values, where the set of measured reference signal values is configured to be obtained from one or more reference signals of a first subset of SSBs in a first SSB burst and one or more reference signals of a second subset of SSBs in a second SSB burst, the first SSB burst and the second SSB burst transmitted in a first set of wireless resources, and where the set of predicted reference signal values is configured to be obtained for the first subset of SSBs for a second set of wireless resources in which the first subset of SSBs is absent. The operations of 2105 may be performed in accordance with examples as disclosed herein. In some examples, aspects of the operations of 2105 may be performed by a reference signal measurement manager 1525 as described with reference to FIG. 15.

At 2110, the method may include transmitting, in the first set of wireless resources, one or more reference signals of the first subset of SSBs in a first instance of the first SSB burst and one or more reference signals of the second subset of SSBs in a first instance of the second SSB burst, where the first subset of SSBs is transmitted using a different set of transmit spatial filters than the second subset of SSBs. The operations of 2110 may be performed in accordance with examples as disclosed herein. In some examples, aspects of the operations of 2110 may be performed by an SSB transmission manager 1530 as described with reference to FIG. 15.

At 2115, the method may include transmitting, in the second set of wireless resources, one or more reference signals of the second subset of SSBs in a second instance of the second SSB burst. The operations of 2115 may be performed in accordance with examples as disclosed herein. In some examples, aspects of the operations of 2115 may be performed by an SSB transmission manager 1530 as described with reference to FIG. 15.

At 2120, the method may include receiving a random access message from the UE in a set of random access resources, where the set of random access resources is associated with at least one SSB of the first subset of SSBs or the second subset of SSBs. The operations of 2120 may be performed in accordance with examples as disclosed herein. In some examples, aspects of the operations of 2120 may be performed by a resource selection manager 1535 as described with reference to FIG. 15.

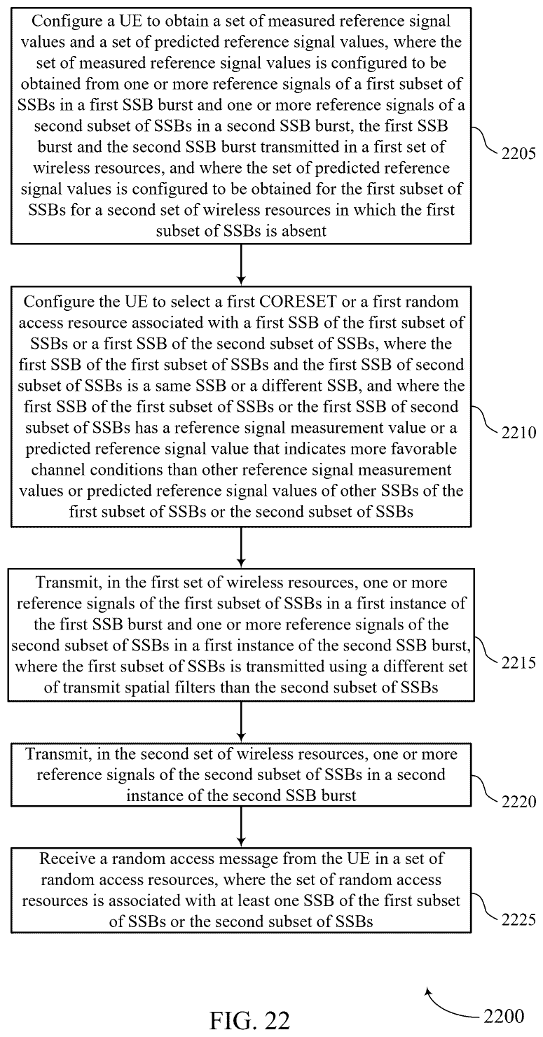

FIG. 22 shows a flowchart illustrating a method 2200 that supports spatial beam prediction for dual-cycle SSB bursts in accordance with one or more aspects of the present disclosure. The operations of the method 2200 may be implemented by a network entity or its components as described herein. For example, the operations of the method 2200 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2205, the method may include configuring a UE to obtain a set of measured reference signal values and a set of predicted reference signal values, where the set of measured reference signal values is configured to be obtained from one or more reference signals of a first subset of SSBs in a first SSB burst and one or more reference signals of a second subset of SSBs in a second SSB burst, the first SSB burst and the second SSB burst transmitted in a first set of wireless resources, and where the set of predicted reference signal values is configured to be obtained for the first subset of SSBs for a second set of wireless resources in which the first subset of SSBs is absent. The operations of 2205 may be performed in accordance with examples as disclosed herein. In some examples, aspects of the operations of 2205 may be performed by a reference signal measurement manager 1525 as described with reference to FIG. 15.

At 2210, the method may include configuring the UE to select a first CORESET or a first random access resource associated with a first SSB of the first subset of SSBs or a first SSB of the second subset of SSBs, where the first SSB of the first subset of SSBs and the first SSB of second subset of SSBs is a same SSB or a different SSB, and where the first SSB of the first subset of SSBs or the first SSB of second subset of SSBs has a reference signal measurement value or a predicted reference signal value that indicates more favorable channel conditions than other reference signal measurement values or predicted reference signal values of other SSBs of the first subset of SSBs or the second subset of SSBs. The operations of 2210 may be performed in accordance with examples as disclosed herein. In some examples, aspects of the operations of 2210 may be performed by a resource selection manager 1535 as described with reference to FIG. 15.

At 2215, the method may include transmitting, in the first set of wireless resources, one or more reference signals of the first subset of SSBs in a first instance of the first SSB burst and one or more reference signals of the second subset of SSBs in a first instance of the second SSB burst, where the first subset of SSBs is transmitted using a different set of transmit spatial filters than the second subset of SSBs. The operations of 2215 may be performed in accordance with examples as disclosed herein. In some examples, aspects of the operations of 2215 may be performed by an SSB transmission manager 1530 as described with reference to FIG. 15.

At 2220, the method may include transmitting, in the second set of wireless resources, one or more reference signals of the second subset of SSBs in a second instance of the second SSB burst. The operations of 2220 may be performed in accordance with examples as disclosed herein. In some examples, aspects of the operations of 2220 may be performed by an SSB transmission manager 1530 as described with reference to FIG. 15.

At 2225, the method may include receiving a random access message from the UE in a set of random access resources, where the set of random access resources is associated with at least one SSB of the first subset of SSBs or the second subset of SSBs. The operations of 2225 may be performed in accordance with examples as disclosed herein. In some examples, aspects of the operations of 2225 may be performed by a resource selection manager 1535 as described with reference to FIG. 15.

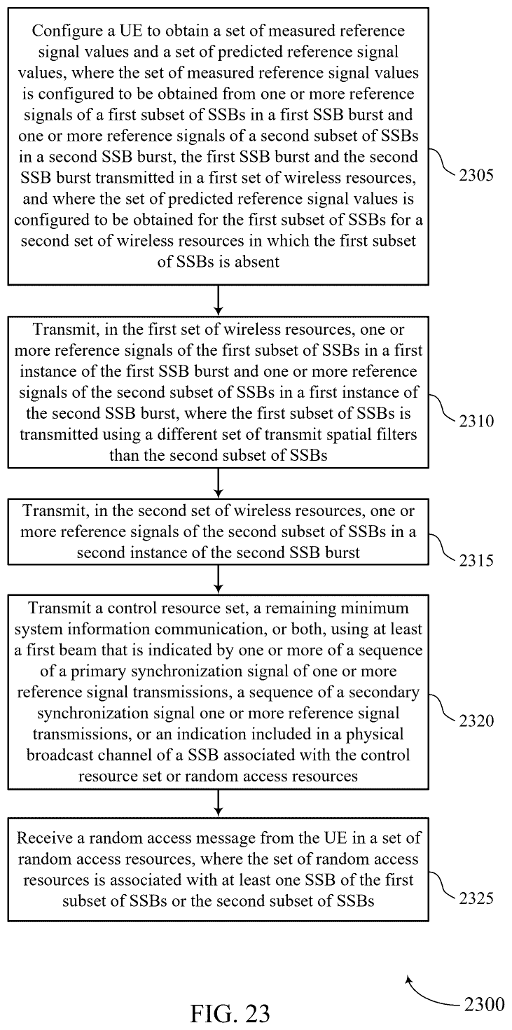

FIG. 23 shows a flowchart illustrating a method 2300 that supports spatial beam prediction for dual-cycle SSB bursts in accordance with one or more aspects of the present disclosure. The operations of the method 2300 may be implemented by a network entity or its components as described herein. For example, the operations of the method 2300 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2305, the method may include configuring a UE to obtain a set of measured reference signal values and a set of predicted reference signal values, where the set of measured reference signal values is configured to be obtained from one or more reference signals of a first subset of SSBs in a first SSB burst and one or more reference signals of a second subset of SSBs in a second SSB burst, the first SSB burst and the second SSB burst transmitted in a first set of wireless resources, and where the set of predicted reference signal values is configured to be obtained for the first subset of SSBs for a second set of wireless resources in which the first subset of SSBs is absent. The operations of 2305 may be performed in accordance with examples as disclosed herein. In some examples, aspects of the operations of 2305 may be performed by a reference signal measurement manager 1525 as described with reference to FIG. 15.

At 2310, the method may include transmitting, in the first set of wireless resources, one or more reference signals of the first subset of SSBs in a first instance of the first SSB burst and one or more reference signals of the second subset of SSBs in a first instance of the second SSB burst, where the first subset of SSBs is transmitted using a different set of transmit spatial filters than the second subset of SSBs. The operations of 2310 may be performed in accordance with examples as disclosed herein. In some examples, aspects of the operations of 2310 may be performed by an SSB transmission manager 1530 as described with reference to FIG. 15.

At 2315, the method may include transmitting, in the second set of wireless resources, one or more reference signals of the second subset of SSBs in a second instance of the second SSB burst. The operations of 2315 may be performed in accordance with examples as disclosed herein. In some examples, aspects of the operations of 2315 may be performed by an SSB transmission manager 1530 as described with reference to FIG. 15.

At 2320, the method may include transmitting a CORESET, a RMSI communication, or both, using at least a first beam that is indicated by one or more of a sequence of a PSS of one or more reference signal transmissions, a sequence of a SSS one or more reference signal transmissions, or an indication included in a PBCH of a SSB associated with the CORESET or random access resources. The operations of 2320 may be performed in accordance with examples as disclosed herein. In some examples, aspects of the operations of 2320 may be performed by a CORESET selection manager 1540 as described with reference to FIG. 15.

At 2325, the method may include receiving a random access message from the UE in a set of random access resources, where the set of random access resources is associated with at least one SSB of the first subset of SSBs or the second subset of SSBs. The operations of 2325 may be performed in accordance with examples as disclosed herein. In some examples, aspects of the operations of 2325 may be performed by a resource selection manager 1535 as described with reference to FIG. 15.

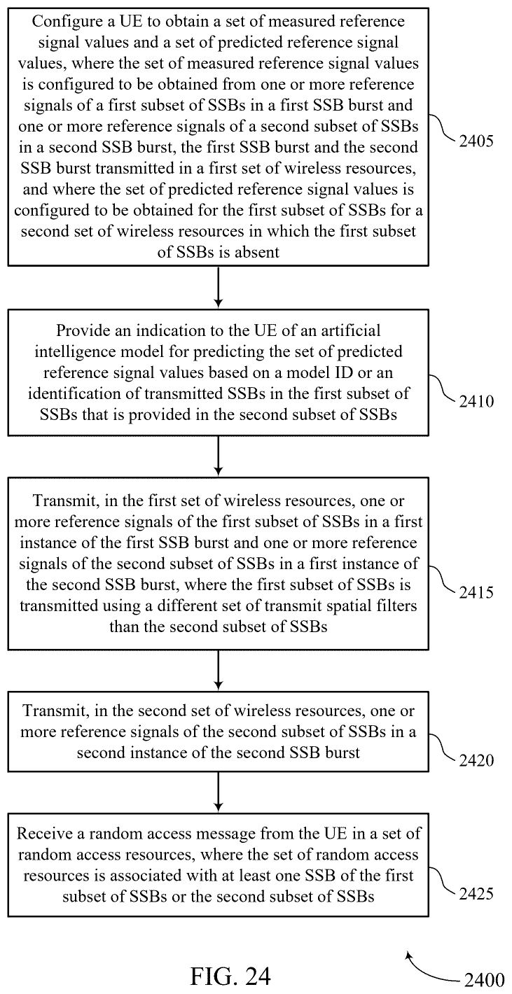

FIG. 24 shows a flowchart illustrating a method 2400 that supports spatial beam prediction for dual-cycle SSB bursts in accordance with one or more aspects of the present disclosure. The operations of the method 2400 may be implemented by a network entity or its components as described herein. For example, the operations of the method 2400 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2405, the method may include configuring a UE to obtain a set of measured reference signal values and a set of predicted reference signal values, where the set of measured reference signal values is configured to be obtained from one or more reference signals of a first subset of SSBs in a first SSB burst and one or more reference signals of a second subset of SSBs in a second SSB burst, the first SSB burst and the second SSB burst transmitted in a first set of wireless resources, and where the set of predicted reference signal values is configured to be obtained for the first subset of SSBs for a second set of wireless resources in which the first subset of SSBs is absent. The operations of 2405 may be performed in accordance with examples as disclosed herein. In some examples, aspects of the operations of 2405 may be performed by a reference signal measurement manager 1525 as described with reference to FIG. 15.

At 2410, the method may include providing an indication to the UE of an artificial intelligence model for predicting the set of predicted reference signal values based on a model ID or an identification of transmitted SSBs in the first subset of SSBs that is provided in the second subset of SSBs. The operations of 2410 may be performed in accordance with examples as disclosed herein. In some examples, aspects of the operations of 2410 may be performed by a prediction manager 1545 as described with reference to FIG. 15.

At 2415, the method may include transmitting, in the first set of wireless resources, one or more reference signals of the first subset of SSBs in a first instance of the first SSB burst and one or more reference signals of the second subset of SSBs in a first instance of the second SSB burst, where the first subset of SSBs is transmitted using a different set of transmit spatial filters than the second subset of SSBs. The operations of 2415 may be performed in accordance with examples as disclosed herein. In some examples, aspects of the operations of 2415 may be performed by an SSB transmission manager 1530 as described with reference to FIG. 15.

At 2420, the method may include transmitting, in the second set of wireless resources, one or more reference signals of the second subset of SSBs in a second instance of the second SSB burst. The operations of 2420 may be performed in accordance with examples as disclosed herein. In some examples, aspects of the operations of 2420 may be performed by an SSB transmission manager 1530 as described with reference to FIG. 15.

At 2425, the method may include receiving a random access message from the UE in a set of random access resources, where the set of random access resources is associated with at least one SSB of the first subset of SSBs or the second subset of SSBs. The operations of 2425 may be performed in accordance with examples as disclosed herein. In some examples, aspects of the operations of 2425 may be performed by a resource selection manager 1535 as described with reference to FIG. 15.

The following provides an overview of aspects of the present disclosure:

Aspect 1: A method for wireless communications at a UE, comprising: obtaining a set of measured reference signal values from one or more reference signals of a first subset of synchronization signal blocks (SSBs) in a first SSB burst and one or more reference signals of a second subset of SSBs in a second SSB burst, wherein the first SSB burst and the second SSB burst are transmitted in a first set of wireless resources, and the first subset of SSBs is transmitted using a different set of transmit spatial filters than the second subset of SSBs; predicting one or more reference signal measurements for one or more SSBs of the first subset of SSBs for a second set of wireless resources to obtain a set of predicted reference signal values, wherein the first subset of SSBs is absent from the second set of wireless resources; and selecting one of a control resource set or a set of random access resources for a random access transmission based at least in part on the set of measured reference signal values and the set of predicted reference signal values.

Aspect 2: The method of aspect 1, wherein the first subset of SSBs are transmitted at a first periodicity and the second subset of SSBs are transmitted at a second periodicity, and wherein the first periodicity divided by the second periodicity is an integer value that is greater than or equal to 2.

Aspect 3: The method of any of aspects 1 through 2, wherein the selecting one of the control resource set or the set of random access resource comprises: selecting a first control resource set or a first random access resource associated with a first SSB of the first subset of SSBs or a first SSB of the second subset of SSBs, wherein the first SSB of the first subset of SSBs and the first SSB of second subset of SSBs is a same SSB or a different SSB, and wherein the first SSB of the first subset of SSBs or the first SSB of second subset of SSBs has a reference signal measurement value or a predicted reference signal value that indicates more favorable channel conditions than other reference signal measurement values or predicted reference signal values of other SSBs of the first subset of SSBs or the second subset of SSBs.

Aspect 4: The method of any of aspects 1 through 3, wherein the first subset of SSBs and the second subset of SSBs each comprise one or more SSBs having one or more symbol structures that include one or more combinations of a first quantity of symbols that include a primary synchronization signal, a second quantity of symbols that include a secondary synchronization signal, and a third quantity of symbols that include a physical broadcast channel.

Aspect 5: The method of aspect 4, wherein each SSB of both the first subset of SSBs and the second subset of SSBs has a same symbol structure.

Aspect 6: The method of aspect 4, wherein each SSB of the second subset of SSBs includes one or more symbols that contain the primary synchronization signal, and each SSB of the first subset of SSBs includes one or more symbols that contain the secondary synchronization signal and the physical broadcast channel.

Aspect 7: The method of aspect 4, wherein each SSB of the second subset of SSBs has a symbol structure that includes the primary synchronization signal, the secondary synchronization signal, and the physical broadcast channel, and each SSB of the first subset of SSBs has a symbol structure that includes only the primary synchronization signal, only the secondary synchronization signal, or both the primary synchronization signal and the secondary synchronization signal.

Aspect 8: The method of any of aspects 1 through 7, wherein the control resource set, a remaining minimum system information communication, or both, are provided only via one or more beams associated with SSBs of the second subset of SSBs.

Aspect 9: The method of any of aspects 1 through 8, further comprising: selecting one or more beams to monitor for the control resource set, a remaining minimum system information communication, or both, based at least in part on the selected control resource set or random access resources, wherein the one or more beams to monitor are determined based at least in part on one or more of a sequence of a primary synchronization signal, a sequence of a secondary synchronization signal, or an indication included in a physical broadcast channel, transmitted in a SSB associated with the selected control resource set or random access resources.

Aspect 10: The method of any of aspects 1 through 9, wherein the set of random access resources for the random access transmission is selected from a plurality of available sets of random access resources associated with only the first subset of SSBs.

Aspect 11: The method of any of aspects 1 through 10, wherein the set of random access resources for the random access transmission are indicated by a remaining minimum system information transmission associated with a SSB that is selected based at least in part on the set of reference signal measurement values and the predicted reference signal measurement values of the first subset of SSBs.

Aspect 12: The method of any of aspects 1 through 11, wherein the first set of wireless resources comprise a first set of temporal locations within a single cycle associated with the first SSB burst and the second SSB burst, and wherein a first set of transmit spatial filters of the first subset of SSBs at a first temporal location of the first set of temporal locations have a predefined quasi-co-location (QCL) relationship to a second set of transmit spatial filters of the second subset of SSBs at a second temporal location of the first set of temporal locations.

Aspect 13: The method of any of aspects 1 through 12, wherein the first set of wireless resources comprise a first set of temporal locations within a single cycle associated with the first SSB burst and the second SSB burst, and wherein a first set of transmit spatial filters of the first subset of SSBs are indicated by one or more of a synchronization signal sequence or an indicator of a physical broadcast channel of one or more SSBs of the second subset of SSBs.

Aspect 14: The method of any of aspects 1 through 13, further comprising: selecting an artificial intelligence model for predicting the one or more reference signal measurements based at least in part on a model ID or an identification of transmitted SSBs in the first subset of SSBs that is provided in the second subset of SSBs.

Aspect 15: The method of any of aspects 1 through 14, further comprising: selecting an artificial intelligence model for predicting the one or more reference signal measurements based at least in part on a geographical location of the UE and a set of candidate models associated with different geographical locations.

Aspect 16: The method of any of aspects 1 through 15, further comprising: selecting an artificial intelligence model for predicting the one or more reference signal measurements based at least in part on the measured reference signal values of the first subset of SSBs and second subsets of SSBs.

Aspect 17: The method of any of aspects 1 through 16, further comprising: receiving a scheduling message that indicates that a measurement report is to be transmitted that includes at least a portion of the set of predicted reference signal values.

Aspect 18: The method of aspect 17, wherein at least the portion of the set of predicted reference signal values is provided in the measurement report when a reporting periodicity of the measurement report is shorter than a transmission periodicity of the first subset of SSBs.

Aspect 19: The method of any of aspects 17 through 18, wherein at least a portion of the set of measured reference signal values is provided in the measurement report in response to a trigger for an aperiodic measurement report when a timer associated with corresponding measurements is unexpired, and at least the portion of the set of predicted reference signal values is provided in the response to the trigger when the timer associated with the corresponding measurements is expired, and wherein a duration of the timer corresponds to a periodicity of the second subset of SSBs.

Aspect 20: The method of any of aspects 1 through 19, wherein a bandwidth, a quantity of physical resource blocks, a quantity of resource elements, or any combination thereof, of the first subset of SSBs is the same or different than the second subset of SSBs, and wherein the first subset of SSBs has a same quantity or a different quantity of transmit spatial filters as the second subset of SSBs.

Aspect 21: A method for wireless communications at a network entity, comprising: configuring a UE to obtain a set of measured reference signal values and a set of predicted reference signal values, wherein the set of measured reference signal values is configured to be obtained from one or more reference signals of a first subset of synchronization signal blocks (SSBs) in a first SSB burst and one or more reference signals of a second subset of SSBs in a second SSB burst, the first SSB burst and the second SSB burst transmitted in a first set of wireless resources, and wherein the set of predicted reference signal values is configured to be obtained for the first subset of SSBs for a second set of wireless resources in which the first subset of SSBs is absent; transmitting, in the first set of wireless resources, one or more reference signals of the first subset of SSBs in a first instance of the first SSB burst and one or more reference signals of the second subset of SSBs in a first instance of the second SSB burst, wherein the first subset of SSBs is transmitted using a different set of transmit spatial filters than the second subset of SSBs; transmitting, in the second set of wireless resources, one or more reference signals of the second subset of SSBs in a second instance of the second SSB burst; and receiving a random access message from the UE in a set of random access resources, wherein the set of random access resources is associated with at least one SSB of the first subset of SSBs or the second subset of SSBs.

Aspect 22: The method of aspect 21, wherein the first subset of SSBs are transmitted at a first periodicity and the second subset of SSBs are transmitted at a second periodicity, and wherein the first periodicity divided by the second periodicity is an integer value that is greater than or equal to 2.

Aspect 23: The method of any of aspects 21 through 22, wherein configuring the UE further comprises: configuring the UE to select a first control resource set or a first random access resource associated with a first SSB of the first subset of SSBs or a first SSB of the second subset of SSBs, wherein the first SSB of the first subset of SSBs and the first SSB of second subset of SSBs is a same SSB or a different SSB, and wherein the first SSB of the first subset of SSBs or the first SSB of second subset of SSBs has a reference signal measurement value or a predicted reference signal value that indicates more favorable channel conditions than other reference signal measurement values or predicted reference signal values of other SSBs of the first subset of SSBs or the second subset of SSBs.

Aspect 24: The method of any of aspects 21 through 23, wherein the first subset of SSBs and the second subset of SSBs each comprise one or more SSBs having one or more symbol structures that include one or more combinations of a first quantity of symbols that include a primary synchronization signal, a second quantity of symbols that include a secondary synchronization signal, and a third quantity of symbols that include a physical broadcast channel.

Aspect 25: The method of aspect 24, wherein each SSB of both the first subset of SSBs and the second subset of SSBs has a same symbol structure.

Aspect 26: The method of aspect 24, wherein each SSB of the second subset of SSBs includes one or more symbols that contain the primary synchronization signal, and each SSB of the first subset of SSBs includes one or more symbols that contain the secondary synchronization signal and the physical broadcast channel.

Aspect 27: The method of aspect 24, wherein each SSB of the second subset of SSBs has a symbol structure that includes the primary synchronization signal, the secondary synchronization signal, and the physical broadcast channel, and each SSB of the first subset of SSBs has a symbol structure that includes only the primary synchronization signal, only the secondary synchronization signal, or both the primary synchronization signal and the secondary synchronization signal.

Aspect 28: The method of any of aspects 21 through 27, wherein a control resource set, a remaining minimum system information communication, or both, are provided only via one or more beams associated with SSBs of the second subset of SSBs.

Aspect 29: The method of any of aspects 21 through 28, further comprising: transmitting a control resource set, a remaining minimum system information communication, or both, using at least a first beam that is indicated by one or more of a sequence of a primary synchronization signal of one or more reference signal transmissions, a sequence of a secondary synchronization signal one or more reference signal transmissions, or an indication included in a physical broadcast channel of a SSB associated with the control resource set or random access resources.

Aspect 30: The method of any of aspects 21 through 29, wherein the set of random access resources for the random access message is one of a plurality of available sets of random access resources associated with only the first subset of SSBs.

Aspect 31: The method of any of aspects 21 through 30, wherein the set of random access resources for the random access message are indicated by a remaining minimum system information transmission associated with a SSB that is selected by the UE based at least in part on the set of reference signal measurements and the predicted reference signal measurements of the first subset of SSBs.

Aspect 32: The method of any of aspects 21 through 31, wherein the first set of wireless resources comprise a first set of temporal locations within a single cycle associated with the first SSB burst and the second SSB burst, and wherein a first set of transmit spatial filters of the first subset of SSBs have a predefined QCL relationship to a second set of transmit spatial filters of the second subset of SSBs.

Aspect 33: The method of any of aspects 21 through 32, wherein the first set of wireless resources comprise a first set of temporal locations within a single cycle associated with the first SSB burst and the second SSB burst, and wherein a first set of transmit spatial filters of the first subset of SSBs are indicated by one or more of a synchronization signal sequence or an indicator of a physical broadcast channel of one or more SSBs of the second subset of SSBs.

Aspect 34: The method of any of aspects 21 through 33, further comprising: providing an indication to the UE of an artificial intelligence model for predicting the set of predicted reference signal values based at least in part on a model ID or an identification of transmitted SSBs in the first subset of SSBs that is provided in the second subset of SSBs.

Aspect 35: The method of any of aspects 21 through 34, wherein an artificial intelligence model for predicting the set of predicted reference signal values is identified based at least in part on a geographical location of the UE and a set of candidate models associated with different geographical locations.

Aspect 36: The method of any of aspects 21 through 35, wherein an artificial intelligence model for predicting the set of predicted reference signal values is identified based at least in part on the measured reference signal values of the first subset of SSBs and second subsets of SSBs.

Aspect 37: The method of any of aspects 21 through 36, further comprising: transmitting a scheduling message to the UE that indicates that a measurement report is to be provided that includes at least a portion of the set of predicted reference signal values.

Aspect 38: The method of aspect 37, wherein at least the portion of the set of predicted reference signal values is provided in the measurement report when a reporting periodicity of the measurement report is shorter than a transmission periodicity of the first subset of SSBs.

Aspect 39: The method of any of aspects 37 through 38, wherein at least a portion of the set of measured reference signal values is provided in the measurement report in response to a trigger for an aperiodic measurement report when a timer associated with corresponding measurements is unexpired, and at least the portion of the set of predicted reference signal values is provided in the response to the trigger when the timer associated with the corresponding measurements is expired, and wherein a duration of the timer corresponds to a periodicity of the second subset of SSBs.

Aspect 40: The method of any of aspects 21 through 39, wherein a bandwidth, a quantity of physical resource blocks, a quantity of resource elements, or any combination thereof, of the first subset of SSBs is the same or different than the second subset of SSBs, and wherein the first subset of SSBs has a same quantity or a different quantity of transmit spatial filters as the second subset of SSBs.

Aspect 41: A UE for wireless communications, comprising one or more memories storing processor-executable code, and one or more processors coupled with the one or more memories and individually or collectively operable to execute the code to cause the UE to perform a method of any of aspects 1 through 20.

Aspect 42: A UE for wireless communications, comprising at least one means for performing a method of any of aspects 1 through 20.

Aspect 43: A non-transitory computer-readable medium storing code for wireless communications, the code comprising instructions executable by one or more processors to perform a method of any of aspects 1 through 20.

Aspect 44: A network entity for wireless communications, comprising one or more memories storing processor-executable code, and one or more processors coupled with the one or more memories and individually or collectively operable to execute the code to cause the network entity to perform a method of any of aspects 21 through 40.

Aspect 45: A network entity for wireless communications, comprising at least one means for performing a method of any of aspects 21 through 40.

Aspect 46: A non-transitory computer-readable medium storing code for wireless communications, the code comprising instructions executable by one or more processors to perform a method of any of aspects 21 through 40.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
obtain a set of measured reference signal values from one or more reference signals of a first subset of synchronization signal blocks (SSBs) in a first SSB burst and one or more reference signals of a second subset of SSBs in a second SSB burst, wherein the first SSB burst and the second SSB burst are transmitted in a first set of wireless resources, and the first subset of SSBs is transmitted using a different set of transmit spatial filters than the second subset of SSBs;
predict one or more reference signal measurements for one or more SSBs of the first subset of SSBs for a second set of wireless resources to obtain a set of predicted reference signal values, wherein the first subset of SSBs is absent from the second set of wireless resources; and
select one of a control resource set or a set of random access resources for a random access transmission based at least in part on the set of measured reference signal values and the set of predicted reference signal values.

2. The UE of claim 1, wherein the first subset of SSBs are transmitted at a first periodicity and the second subset of SSBs are transmitted at a second periodicity, and wherein the first periodicity divided by the second periodicity is an integer value that is greater than or equal to 2.

3. The UE of claim 1, wherein, to select one of the control resource set or the set of random access resource, the one or more processors are individually or collectively operable to execute the code to cause the UE to:
select a first control resource set or a first random access resource associated with a first SSB of the first subset of SSBs or a first SSB of the second subset of SSBs, wherein the first SSB of the first subset of SSBs and the first SSB of second subset of SSBs is a same SSB or a different SSB, and wherein the first SSB of the first subset of SSBs or the first SSB of second subset of SSBs has a reference signal measurement value or a predicted reference signal value that indicates more favorable channel conditions than other reference signal measurement values or predicted reference signal values of other SSBs of the first subset of SSBs or the second subset of SSBs.

4. The UE of claim 1, wherein the first subset of SSBs and the second subset of SSBs each comprise one or more SSBs having one or more symbol structures that include one or more combinations of a first quantity of symbols that include a primary synchronization signal, a second quantity of symbols that include a secondary synchronization signal, and a third quantity of symbols that include a physical broadcast channel.

5. The UE of claim 4, wherein each SSB of both the first subset of SSBs and the second subset of SSBs has a same symbol structure.

6. The UE of claim 4, wherein each SSB of the second subset of SSBs includes one or more symbols that contain the primary synchronization signal, and each SSB of the first subset of SSBs includes one or more symbols that contain the secondary synchronization signal and the physical broadcast channel.

7. The UE of claim 4, wherein:
each SSB of the second subset of SSBs has a symbol structure that includes the primary synchronization signal, the secondary synchronization signal, and the physical broadcast channel, and
each SSB of the first subset of SSBs has a symbol structure that includes only the primary synchronization signal, only the secondary synchronization signal, or both the primary synchronization signal and the secondary synchronization signal.

8. The UE of claim 1, wherein the control resource set, a remaining minimum system information communication, or both, are provided only via one or more beams associated with SSBs of the second subset of SSBs.

9. The UE of claim 1, wherein the one or more processors are individually or collectively further operable to execute the code to cause the UE to:
select one or more beams to monitor for the control resource set, a remaining minimum system information communication, or both, based at least in part on the selected control resource set or random access resources, wherein the one or more beams to monitor are determined based at least in part on one or more of a sequence of a primary synchronization signal, a sequence of a secondary synchronization signal, or an indication included in a physical broadcast channel, transmitted in a SSB associated with the selected control resource set or random access resources.

10. The UE of claim 1, wherein the set of random access resources for the random access transmission is selected from a plurality of available sets of random access resources associated with only the first subset of SSBs.

11. The UE of claim 1, wherein the set of random access resources for the random access transmission are indicated by a remaining minimum system information transmission associated with a SSB that is selected based at least in part on the set of reference signal measurement values and the predicted reference signal measurement values of the first subset of SSBs.

12. The UE of claim 1, wherein the first set of wireless resources comprise a first set of temporal locations within a single cycle associated with the first SSB burst and the second SSB burst, and wherein a first set of transmit spatial filters of the first subset of SSBs at a first temporal location of the first set of temporal locations have a predefined quasi-co-location (QCL) relationship to a second set of transmit spatial filters of the second subset of SSBs at a second temporal location of the first set of temporal locations.

13. The UE of claim 1, wherein the first set of wireless resources comprise a first set of temporal locations within a single cycle associated with the first SSB burst and the second SSB burst, and wherein a first set of transmit spatial filters of the first subset of SSBs are indicated by one or more of a synchronization signal sequence or an indicator of a physical broadcast channel of one or more SSBs of the second subset of SSBs.

14. The UE of claim 1, wherein the one or more processors are individually or collectively further operable to execute the code to cause the UE to:
select an artificial intelligence model for predicting the one or more reference signal measurements based at least in part on a model ID or an identification of transmitted SSBs in the first subset of SSBs that is provided in the second subset of SSBs.

15. The UE of claim 1, wherein the one or more processors are individually or collectively further operable to execute the code to cause the UE to:
select an artificial intelligence model for predicting the one or more reference signal measurements based at least in part on a geographical location of the UE and a set of candidate models associated with different geographical locations.

16. The UE of claim 1, wherein the one or more processors are individually or collectively further operable to execute the code to cause the UE to:
select an artificial intelligence model for predicting the one or more reference signal measurements based at least in part on the measured reference signal values of the first subset of SSBs and second subsets of SSBs.

17. The UE of claim 1, wherein the one or more processors are individually or collectively further operable to execute the code to cause the UE to:
receive a scheduling message that indicates that a measurement report is to be transmitted that includes at least a portion of the set of predicted reference signal values.

18. The UE of claim 17, wherein at least the portion of the set of predicted reference signal values is provided in the measurement report when a reporting periodicity of the measurement report is shorter than a transmission periodicity of the first subset of SSBs.

19. The UE of claim 17, wherein at least a portion of the set of measured reference signal values is provided in the measurement report in response to a trigger for an aperiodic measurement report when a timer associated with corresponding measurements is unexpired, and at least the portion of the set of predicted reference signal values is provided in the response to the trigger when the timer associated with the corresponding measurements is expired, and wherein a duration of the timer corresponds to a periodicity of the second subset of SSBs.

20. The UE of claim 1, wherein a bandwidth, a quantity of physical resource blocks, a quantity of resource elements, or any combination thereof, of the first subset of SSBs is the same or different than the second subset of SSBs, and wherein the first subset of SSBs has a same quantity or a different quantity of transmit spatial filters as the second subset of SSBs.

21. A network entity, comprising:
one or more memories storing processor-executable code; and
one or more processors coupled with the one or more memories and individually or collectively operable to execute the code to cause the network entity to:
configure a user equipment (UE) to obtain a set of measured reference signal values and a set of predicted reference signal values, wherein the set of measured reference signal values is configured to be obtained from one or more reference signals of a first subset of synchronization signal blocks (SSBs) in a first SSB burst and one or more reference signals of a second subset of SSBs in a second SSB burst, the first SSB burst and the second SSB burst transmitted in a first set of wireless resources, and wherein the set of predicted reference signal values is configured to be obtained for the first subset of SSBs for a second set of wireless resources in which the first subset of SSBs is absent;
transmit, in the first set of wireless resources, one or more reference signals of the first subset of SSBs in a first instance of the first SSB burst and one or more reference signals of the second subset of SSBs in a first instance of the second SSB burst, wherein the first subset of SSBs is transmitted using a different set of transmit spatial filters than the second subset of SSBs;
transmit, in the second set of wireless resources, one or more reference signals of the second subset of SSBs in a second instance of the second SSB burst; and
receive a random access message from the UE in a set of random access resources, wherein the set of random access resources is associated with at least one SSB of the first subset of SSBs or the second subset of SSBs.

22. The network entity of claim 21, wherein the first subset of SSBs are transmitted at a first periodicity and the second subset of SSBs are transmitted at a second periodicity, and wherein the first periodicity divided by the second periodicity is an integer value that is greater than or equal to 2.

23. The network entity of claim 21, wherein the first subset of SSBs and the second subset of SSBs each comprise one or more SSBs having one or more symbol structures that include one or more combinations of a first quantity of symbols that include a primary synchronization signal, a second quantity of symbols that include a secondary synchronization signal, and a third quantity of symbols that include a physical broadcast channel.

24. The network entity of claim 21, wherein a control resource set, a remaining minimum system information communication, or both, are provided only via one or more beams associated with SSBs of the second subset of SSBs.

25. The network entity of claim 21, wherein the one or more processors are individually or collectively further operable to execute the code to cause the network entity to:
provide an indication to the UE of an artificial intelligence model for predicting the set of predicted reference signal values based at least in part on a model ID or an identification of transmitted SSBs in the first subset of SSBs that is provided in the second subset of SSBs.

26. The network entity of claim 21, wherein the one or more processors are individually or collectively further operable to execute the code to cause the network entity to:
transmit a scheduling message to the UE that indicates that a measurement report is to be provided that includes at least a portion of the set of predicted reference signal values.

27. A method for wireless communications at a user equipment (UE), comprising:
obtaining a set of measured reference signal values from one or more reference signals of a first subset of synchronization signal blocks (SSBs) in a first SSB burst and one or more reference signals of a second subset of SSBs in a second SSB burst, wherein the first SSB burst and the second SSB burst are transmitted in a first set of wireless resources, and the first subset of SSBs is transmitted using a different set of transmit spatial filters than the second subset of SSBs;
predicting one or more reference signal measurements for one or more SSBs of the first subset of SSBs for a second set of wireless resources to obtain a set of predicted reference signal values, wherein the first subset of SSBs is absent from the second set of wireless resources; and
selecting one of a control resource set or a set of random access resources for a random access transmission based at least in part on the set of measured reference signal values and the set of predicted reference signal values.

28. The method of claim 27, wherein the selecting one of the control resource set or the set of random access resource comprises:
selecting a first control resource set or a first random access resource associated with a first SSB of the first subset of SSBs or a first SSB of the second subset of SSBs, wherein the first SSB of the first subset of SSBs and the first SSB of second subset of SSBs is a same SSB or a different SSB, and wherein the first SSB of the first subset of SSBs or the first SSB of second subset of SSBs has a reference signal measurement value or a predicted reference signal value that indicates more favorable channel conditions than other reference signal measurement values or predicted reference signal values of other SSBs of the first subset of SSBs or the second subset of SSBs.

29. The method of claim 27, further comprising:
selecting one or more beams to monitor for the control resource set, a remaining minimum system information communication, or both, based at least in part on the selected control resource set or random access resources, wherein the one or more beams to monitor are determined based at least in part on one or more of a sequence of a primary synchronization signal, a sequence of a secondary synchronization signal, or an indication included in a physical broadcast channel, transmitted in a SSB associated with the selected control resource set or random access resources.

30. The method of claim 27, further comprising:
selecting an artificial intelligence model for predicting the one or more reference signal measurements based at least in part on the measured reference signal values of the first subset of SSBs and second subsets of SSBs.
